(19) United States
(12) Patent Application Publication
(10) Pub. No.: US 2002/0147622 A1
(43) Pub. Date: Oct. 10, 2002

(54) System and method for enabling a configurable electronic business exchange platform

(75) Inventors: Thomas Drolet, Germantown, MD (US); Michael L. Hooks, Germantown, MD (US); Robert Mitchell, North Potomac, MD (US); Ed Kennedy, Rockville, MD (US); Charles Korolevich, Rockville, MD (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc., Rockville, MD

(21) Appl. No.: 10/020,188

(22) Filed: Dec. 18, 2001

Related U.S. Application Data
(60) Provisional application No. 60/255,880, filed on Dec. 18, 2000.

(51) Int. Cl. G06F 17/60

(52) U.S. Cl. 705/7

(57) ABSTRACT

The invention provides a system and method for using an electronic hub to facilitate supply chain management through the creation of business rules that monitor critical supply chain parameters and the subsequent generation of alert notifications to inform suppliers and buyers of violations to the business rules. The invention further provides a method and system for allowing supply chain participants to view the data associated with an alert notification through customized report generation or drill down menus that allow the participants to actively search the relevant database.

### CROSS REFERENCE TO RELATED APPLICATION

This application claims priority from U.S. Provisional Patent Application Serial No. 60/255,880, filed Dec. 18, 2000, the disclosure of which is hereby incorporated by reference in its entirety.

### FIELD OF THE INVENTION

The present invention relates to systems and methods for providing a configurable electronic business exchange platform. More particularly, the present invention provides systems and methods for allowing organizations to receive, analyze and respond to real-time information from supply chain partners through the monitoring of configurable supply chain parameters

### BACKGROUND OF THE INVENTION

Within the modern economy, the supply of goods and products is increasingly critical to the success of an organization. For example, businesses that operate on the Internet typically must transport goods to customers with every order. For these Internet businesses, product supply is not merely a simple business function that must be managed, but rather a strategic function that influences revenue generation and customer satisfaction. More specifically, a business having relatively higher inventory costs and/or relatively slower or less reliable delivery of their products and goods is at a severe competitive disadvantage.

Accordingly, many organizations devote a high level of logistic resources to supply chain management of their goods and products. For example, depending on the industry in which an organization competes, the management of supply-chain factors may account for up to half of the organization's total logistics cost. A supply chain is typically a reticulated network of people and organizations interacting dynamically to supply and sell their products and services.

Adding to the difficulty of managing supply chain factors is the complex relationship between trading partners, which is often adversarial. A trading partner may be a supplier, customer, subsidiary, or any other organization or person that participates in the same supply chain or trading network.

Given the immense importance of supply-chain factors to the overall health of an organization, organizations have understandably attempted to develop a variety of techniques for negotiating the myriad of parameters involved in their supply-chain functions. Most of the conventional negotiating techniques require substantial human involvement for every step from production to product delivery. Unfortunately, due to the reliance on human intervention, if predetermined requirements are violated, a person in the organization must be notified to ensure that necessary changes or corrections are effected.

The ability to respond quickly and efficiently to problems in purchasing and supplying goods and services is necessary for an organization's survival in today's dynamic global marketplace. Minimizing an organization's response time to problems allows the organization to promptly enact appropriate adjustments to avoid adverse results.

Problems often occur in product supply and procurement for a variety of reasons. For example, market participants may have logistically impeding legal commitments, manufacturers may require lag times to make remedial changes to production quantities, inventory space may be limited, etc. To overcome such problems, market participants may require increased synergy, often based on business forecasts that attempt to predict future business indicators.

Developing reliable forecasts that maximize participant synergy, however, requires information that is current and accurate. Unfortunately, it is often very difficult for trading partners to obtain relevant and accurate information on a timely basis. For example, conventional monitoring techniques are often too slow to respond adequately to adverse changes in market parameters. The delay in responding to adverse changes may largely be attributable to the extensive human involvement in conventional systems, which leads to delays in detecting changes in the marketplace or to inadequate communication with other market participants. These delays are a direct consequence of the need for human notification and interaction to remedy market concerns.

The inability of trading participants to share information is exacerbated by the fact that businesses often use different management systems. As a result, relevant information is often unavailable simply because there is no system for sharing information among market participants.

Further increasing the difficulties inherent in managing market parameters is the general dynamic nature of the spot market. Market producers and suppliers are typically a complex network of organizations that is constantly evolving. Market participants, therefore, may need to be included and excluded as business relationships constantly realign themselves. Although the ability to include, or exclude, market participants brings great flexibility, it dramatically increases the difficulties of providing each participant with necessary, relevant information on a real-time basis.

Thus, a system that overcomes the deficiencies in the current marketplace monitoring methodologies is desirable. Further, an electronic data network that allows transacting companies to efficiently share order and shipment data with trading partners is desirable. In particular, an automated system that is configurable to the needs of market participants, provides supply chain partners with a common view of supply and demand information, allows market participants to negotiate and bid on goods and services, establishes dynamic product pricing, establishes custom business rules, monitors whether those business rules are met or violated, and provides real-time notices, or alerts, to those participants designated to receive them would be highly desirable. Further, an automated system that provides trading partners with reports detailing the cause of the alert and providing a user with the capacity to search relevant data fields and drill down menus to review specific data would likewise be highly desirable. Such a system will dramatically improve market efficiency, allowing for better-on time delivery, increased response time, shorter fulfillment time, less inventory investment, higher productivity per employee, improvement in cash-to-cash cycle time and fewer investments in material acquisition.

### SUMMARY OF THE INVENTION

In view of the deficiencies in the conventional supply chain management methodologies described above, the invention provides a trading platform that allows numerous supply chain partners to interact and monitor relevant supply chain parameters.

Further, the invention provides a mechanism for efficiently linking trading partners into a commonly accessible electronic trading platform.

The invention also provides a mechanism through which trading partners may view their combined supply chains and consolidate their related shipments.

The present invention also provides a platform that is accessible by one or more trading partners via the Internet, EDI, or other conventional electronic communication methods. Thus, a single party may manage the exchanges between trading partners, in an end-to-end fashion.

Furthermore, embodiments of the present invention allow for capabilities such as content aggregation, profile management and personalization, information repository, real-time alert generation and management, data and functional security, and integration with financial clearinghouse functions. The open architecture of the present invention enables a modular, end-to-end e-business platform that can be configured to fit each trading partner's existing technology infrastructure and integrate with other technology providers.

The present invention also allows trading partners to react to customized business rule exceptions in a real-time Internet environment. The customized business rules are continuously evaluated to ensure prompt and reliable delivery of relevant information to the appropriate trading partners in a real-time environment. The efficient delivery of relevant information enables trading managers to provide individual attention to those orders that have violated the customized business rules.

The invention further provides a plug-and-play integration that enables best-of-breed solutions with leading technology providers. This functionality enables trading partners to utilize software applications and network technologies that minimize cost and maximize system effectiveness.

Additional features and advantages of the invention are set forth in the description that follows, and in part are apparent from the description, or may be learned by practice of the invention. The objectives and other advantages of the invention are realized and attained by the structure particularly pointed out in the in the written description and claims thereof, as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are intended to provide further understanding of the invention and are incorporated in and constitute a part of this specification, illustrate embodiments of the invention and together with the description serve to explain the principles of the invention. In the drawings with like reference numerals representing corresponding parts throughout:

FIG. 1 is a block diagram of the configurable electronic business exchange system in accordance with an embodiment of the invention;

FIG. 2 is a block diagram illustrating the dataflow process in accordance with an embodiment of the invention;

FIGS. 3a-b are flowcharts illustrating the process for business rule processing and alert generation in accordance with an embodiment of the invention;

FIGS. 4a-b are flowcharts illustrating the process for determining an expected delivery discrepancy in accordance with an embodiment of the invention;

FIGS. 5a-b are flowcharts illustrating the process for identifying unplaced purchase orders in accordance with an embodiment of the invention;

FIG. 6 is a flowchart illustrating the process for identifying late purchase order receipts in accordance with an embodiment of the invention;

FIG. 7 is a flowchart illustrating the process for identifying late sales order shipments in accordance with an embodiment of the invention;

FIG. 8 is a flowchart illustrating the process for identifying late trigger starts in accordance with an embodiment of the invention;

FIGS. 9a-b are flowcharts illustrating the process for identifying a supply demand disconnect in accordance with an embodiment of the invention;

FIGS. 10a-b are flowcharts illustrating the process for identifying a baseline disconnect in accordance with one embodiment of the invention;

FIGS. 11 a-b are flowcharts illustrating the process for identifying a forecast time fence disconnect in accordance with one embodiment of the invention;

FIG. 12 is a flowchart illustrating the process for identifying a lead time disconnect in accordance with one embodiment of the invention;

FIGS. 13a-b are flowcharts illustrating the process for identifying a sales order change in accordance with one embodiment of the invention;

FIGS. 14a-b are flowcharts illustrating the process for identifying a top level demand disconnect in accordance with one embodiment of the invention;

FIG. 15 is a flowchart illustrating the process for identifying a lead-time/delivery date disconnect in accordance with one embodiment of the invention; and

FIG. 16 is a flowchart illustrating the process for identifying a bill of material disconnect in accordance with one embodiment of the invention.

### DETAILED DESCRIPTION OF THE PREFERRED EMBODIMENTS

Reference is now made in detail to preferred embodiments of the present invention, examples of which are illustrated in the accompanying drawings. The invention disclosed herein incorporates by reference the subject matter of co-pending and commonly assigned U.S. Non-Provisional Patent Applications “System and Method for Optimizing Resource Plans,” Shekar et al., Attorney Docket No. 82001-0198, filed Oct. 29, 2001; and “System and Method for Supply Chain Management, Including Collaboration,” Zarefoss et al., Attorney Docket No. 82001-0189, filed Oct. 1, 2001; and “System and method of Monitoring supply chain parameters,” Zarefoss et al., Attorney Docket No. 82001-0199.

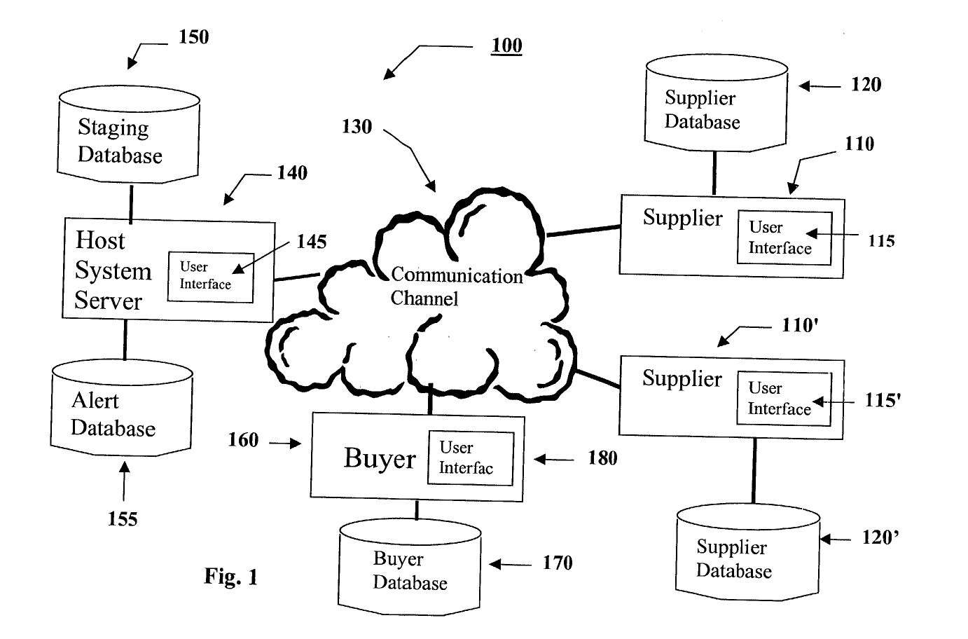

As shown in FIG. 1, the configurable electronic business exchange system 100 in accordance with the invention provides a universal interface for a buyer and/or a supplier to manage their supply chain alerts and metrics. The system 100 alerts a supply chain community to critical business information and problems within a supply chain and provides a central interface to this information. FIG. 1 shows a host system server 140 communicatively coupled to one or more suppliers 110 and 110′ and one or more buyers 160 (although only one buyer is shown, multiple buyers may participate in the system) via a communication channel 130. The communication channel 130 may be any medium or network through which communications may take place, such as but not limited to the Internet, intranet, Plain-Old-Telephone-Service (“POTS”), terrestrial connections, wireless channels and satellites. Each supplier 110 and 110′ is communicatively coupled to an associated supplier user interface 115 and 115′ and a supplier database 120 and 120′. Similarly, each buyer 160 is communicatively coupled to a buyer user interface 180 and an associated buyer database 170. The host system server 140 is communicatively coupled to a host user interface 145, as well as a staging database 150 and an alert database 155.

In operation, the buyer 160, supplier 110, host system server 140, or any other related supply chain participant, e.g., a contract manufacturer, configures a business rule by establishing the parameters, or attributes, of the business rule and communicating the business rule, and its associated parameters to the host system server 140 via the communication channel 130. Such a business rule could be a determining an expected delivery discrepancy business rule which is executed to identify whether a misunderstanding between a buy side supply chain participant and a sell side supply chain participant as to the expected delivery date of a specific product is greater than a maximum threshold value.

During the configuration process, the entity configuring the rule may establish any number of buyers 160 and/or sellers 110 to have the role of a supply chain partner for the configured business rule, and thus be a configured partner for the rule. A business rule also includes properties that establish the criteria to be used with the user-defined parameters to determine whether an alert notice should be generated. Alert notices are generated when either violations to the business rule, or triggering events defined by the rule, have occurred. A violation of the business rule may occur when a particular item, i.e., a supply chain parameter, does not conform to a predefined business requirement. For example, if the inventory of a particular product falls below a threshold level, an alert notice may be generated.

The business rule application may be configured, or defined, by a supplier 110 or a buyer 160, i.e., a supply chain partner, through either direct access to the staging database 150 through a host user interface 145, a buyer user interface 180, or a supplier user interface 115. In each case, the appropriate user interface 115, 145, or 180 may be configurable, provide access to view and analyze critical alerts, exceptions and success factors, and extensible to include other tools and links. The user interfaces 115, 145, or 180 may be designed in any programming language that allows network interfacing, such as Java, and may be portable so that it can be used on any platform. The user interfaces 115, 145, or 180 provide the interface through which the buyer 160 or the supplier 110 may view relevant supply chain data and alert notifications. These interfaces may be responsible for transmitting search requests to relevant databases and may be customized to the specifications of the buyer 160 or supplier 110 that it serves.

The host system server 140 processes the business rule after receiving from the user the properties, or parameters, that define the rule. Properties or parameters that may be received from the user include, but are not limited to, the specific product about which the business rule is examining data and/or the ID of the entity that is a supply chain partner with the entity that configured the business rule. The host system server 140 is also the access point into the supply chain network for the entity that is hosting or sponsoring the supply chain network. The parameter data may be received from the supplier user interface 115 or the buyer user interface 160 and stored in the staging database 150, before being imported into the alert database 155. The host system server 140 may then initiate an observation of the data stored in the alert database 155, supplier database 120, or buyer database 170. If a violation of the business rule occurs, the host system server 140 may generate the alert notifications and be responsible for sending the notifications to authorized suppliers 110 and buyers 160. The process of alert generation and notification will be discussed in greater detail below.

The supplier 110, or buyer 160, may be a warehouse, a factory, a retailer, or any other supply-chain participant that has been given permission to receive an alert notification of a violation for a specific business rule. Permission to receive an alert notification is granted to a supplier 110, or buyer 160, through the definition of the role of the buyer or supplier, when the business rule is created, or configured. That is, a supplier 110 or a buyer 160 may be given permission to receive an alert notification to a business rule during the creation of the business rule if the entity creating the business rule defines the role of the supplier 110 and/or buyer 160 to include participation in the business rule. Permission to receive an alert notification may also be granted to the host system server 140 that manages the data flow in the present invention. The entity configuring the business rule generally should have system privileges to configure the escalation/notification levels for the business rule. Escalation levels will be discussed in greater detail below.

A business rule participation list may be maintained in the host system server 140 and/or the alert database 155 for each business rule and lists the names of each supplier 110 and/or buyer 160 that is a participant to that specific rule. If the supplier 110 and/or the buyer 160 is granted permission to receive an alert notification, the system server 140 will send the supplier 110 and/or the buyer 160 an alert notification for violations of each business rule that the supplier 110 and/or buyer 160 has permission to review.

The buyer 160 and/or supplier 110 that receives the alert notification may use the alert to drill down into additional supporting information as appropriate for the specific alert. This information is stored either in the alert database 155, the buyer database 170, and/or the supplier database 120 and is transmitted to the buyer 160 and/or supplier 110 via the communication channel and is displayed on the buyer user interface 170 and/or supplier user interface 115. Therefore, drill down menus provide a buyer 160 or a supplier 110 with the ability to get more information about the supply chain across the system 100 upon receipt of an alert. For example, if a buyer 160 received an alert that a product that the supplier 110 was shipping is insufficient as to quantity shipped, the buyer 160 could search the related data fields stored in the supplier database 120 by using the drill down menus associated with the received alert to initiate the search request.

The drill down menus that may be utilized to initiate a search request include, but are not limited to, approved vendor list, buy-side part master, demand pegging, excess available, forecast profile, forecast waterfall, forecast waterfall with time fence profile, notification history, purchase order (PO) detail, sell-side part master, sales order (SO) detail, supply/demand profile, supply detail, and where used.

For illustrative purposes only, each of the above drill down menu options will be briefly discussed. The approved vendor list drill down provides a list of vendors that also supply the item, or part number (P/N), that is the subject matter of the received alert. The buy-side part master drill down provides a list of attributes, such as inventory levels and forecasted demand, from the buyer's part master list. The demand pegging drill down provides a list of components and their associated demand for the specified date. The excess available drill down provides a list of supply chain partners that have excess items available of the relevant P/N. The information included in this search could include the names of the supply chain partners and their e-mail address, which is linked to a launch configured mailer.

The forecast profile drill down provides a grid of data that represents the top-level demand for the relevant P/N over time and the expected load on manufacturing production systems (MPS), as well as the cumulative of each and the rolling difference, or delta, between the two. The time periods in which the configured thresholds are exceeded may be highlighted. The forecast waterfall provides the oldest baseline forecast and the current forecast of supply and demand of a particular part for visual comparison.

The PO receipt data is shown as an actual consumption for each baseline forecast. Also shown for each baseline forecast are the totals calculated for the forecast date, forecast variability, cumulative delta, where forecast variability is defined as (max (demand)−min (demand))/min (demand) for a given week.

The forecast waterfall with time fence profile provides the oldest baseline forecast and the current forecast The PO receipt data is shown as actual consumption for each baseline. Also shown for each baseline is MPS date, forecast variability, and cumulative delta. The notification provides a list of those who have been notified of the alert, date/time stamp of when the alert was sent, and at what notification level (one, two, or three). A link is also provided to allow the user to manually escalate the alert to the next level. If a manual escalation level is used, it will be noted in the notification history. The buyer 160 or supplier 110 to whom the alert was sent may also view the notification levels that have not yet been executed by viewing the roles that have been defined for that escalation profile for configured supply-chain partners.

The PO Detail drill down menu provides line item data such as line number, P/N, revision number, quantity, balance due, required date, delivery date, and status. Receipt data is also provided. This data may be line number, delivery date, required quantity, received quantity, remaining quantity, and received date. The sell-side part master drill down provides a list of attributes from the supplier's part master list. The SO detail drill down menu provides line item data such as line number, manufacturer P/N, revision, quantity, balance due, requested delivery date, current delivery date, current ship date, status. Shipment data is also provided. This data may be line number, required quantity, shipped quantity, remaining quantity, shipment identifier, carrier, tracking identification (ID) number.

The supply/demand profile drill down provides a grid of data representing the demand over time, supply over time, as well as the cumulative of each and the rolling difference between the two. The time periods in which the differences exceed the configured thresholds may be highlighted. The supply detail drill down provides a breakdown of the supply components found in the supply partner interface process (PIP), on-hand an on-order. Additionally, this drill down provides supply data, viz., PO number, line number, delivery date, and quantity due, as well as the PO lines corresponding to open standard POs and released blanket POs. A blanket PO is to communicate PO's and Releases that have solely been placed to meet the host's partner's demand. Receipt details for each PO Release must also be included. The “Where Used” drill down provides a list of all P/N that are used within the referenced parts Bill of Material (BOM). If a P/N is not a top-level part, then it will be linked to additional parts with the BOM. This linking process may continue until all P/Ns have been completely exhausted.

The processing of a business rule may cause the host system server 140 to monitor and generate alert notifications for a variety of circumstances and events. For example, the system server 140 may process a business rule by identifying differences between a buy-side supply chain partner's purchase order (“PO”) delivery date and quantity and the sell-side partner's sales order delivery date and quantity. In such an example, the system server 140 could determine whether to generate an alert notification by comparing the relevant supply chain parameters, e.g., PO current delivery date and requested quantity and sales order delivery date and quantity between a supplier 110 and a buyer 160 for each line item and for each part number (P/N). If an alert notification is necessary, the host system server 140 will send a notification to every supplier 110 and buyer 160 that has a role eligible to receive notification. The supplier 110 and/or buyer 160 may view alert notifications from e-mail or any platform capable of executing the monitoring system in accordance with the invention.

The supplier 110 and/or buyer 160 may view alert notifications via scroll down menus on their user interfaces, 115 and 180 respectively. Thus, the supplier 110 and/or buyer 160 may view the notification data in any format they deem relevant. For example, if the buyer 160 wanted to view data pertinent to a part quantity discrepancy with a particular supplier 110, the buyer 160 could sort the alert database by supplier number and scroll down to the relevant fields, thus saving time and resources.

In addition to providing customized search windows, the present invention provides that the host system server 140 can query relevant databases, such as supplier database 120 and buyer database 170, to send to approved suppliers 110 and buyers 160 reports that visually present the supplier 110 and/or buyer 160 with the data associated with an alert notification in a concise and orderly fashion. The reports allow the suppliers 110 and buyers 160 to gain visibility and allows the host system server 140 insight into the status of the entire hub operation. The reports may be formatted in any number of ways. For illustrative purposes only, the following reports: aggregate net demand report, on time delivery report, supply commit report, excess and obsolete report, and supply split report, are discussed in greater detail.

The aggregate net demand report provides the host system server 140 and the supply chain partners with enhanced supply chain visibility by providing suppliers 110 visibility of the total aggregate demand for their parts as well as the net requirements for the buyers 160 to whom they sell. The data columns that the report may provide, but are not limited to, include: sell-side partner ID, manufacturer's P/N, manufacturer's on-hand inventory levels, in-transit inventory, buy-side partner ID, host P/N, plan purchase date, demand for the first week of report, and the demand through the n weeks immediately succeeding the week corresponding to the latest manufacturing resource plan (MRP) run. The MRP run specifies when a supplier needs to make a specific P/N.

The on-time delivery (OTD) reports are utilized for the display of reliability and flexibility metrics. There may be two OTD reports: OTD summary and OTD detail. The OTD summary report provides the supplier 110 and/or buyer 160 with a summary of the OTD metrics for every P/N that was entered into the system by a specified supplier 110 or buyer 160. The supply commit report allows an entity to view a previously generated supply chain report. There may be two types of supply commit reports: summary and detail. The summary report provides a summary of the forecast and commit information for the P/Ns selected by the entity requesting the report. The detail report is a part-specific report that shows detailed forecasts and commit information over a 15 week rolling horizon. The OTD detail reports are specific to the individual part numbers and display the detailed metrics for the individual part numbers and may called from links in the OTD summary report. The data columns that the OTD report may provide, include, but are not limited to: host P/N, part description, weekly delta from target OTD rate, total forecast, trigger value, target value, OTD percentage as measured from target value, monthly OTD percentage and quarterly OTD percentage.

The supply commit reports incorporate existing supply chain data reports. These reports may be of two types: summary and detail. The supply commit summary report summarizes forecast and commit information for the part numbers selected by the entity requesting the report. The supply commit detail report is a part specific report that shows detailed forecast and commit information over a 15 week rolling horizon. The data columns that the supply commit report may provide include, but are not limited to: the MRP organization, buyer ID, supply chain partner ID, host P/N, date of the last forecast, date of the last commit forecast, the on-hand inventory held by the corresponding host planning division, the current week's forecast, the forecast for the 5 previous weeks, the difference between the sum of the total forecast quantities for the first 6 weeks and the sum of the total committed quantities for the same time period, the ratio of the 6-week delta to the 6-week summation of forecast expressed as a percentage, the total forecast, including the current week, to the end of the quarter, and the difference between the forecast and committed totals for the remaining quarter.

The excess and obsolete report highlights situations where supply, i.e., inventory on hand plus that on order, is greater than the demand required over a specified time horizon. The report also highlights situations where the supply exists with no corresponding demand. The data columns that the report provides may include, but are not limited to: host P/N, the total on-hand inventory of the selected supply chain partner for the corresponding P/N form the supply summary PIP, the total on order quantity of the selected supply chain partner for the corresponding P/N from the supply summary PIP, the demand through lead-time for the corresponding P/N, the excess inventory at lead time, the value of the excess inventory, the total demand for all periods in the future including the current week from the gross demand, the amount of obsolete inventory if no demand for the P/N exists, and the total excess demand.

The supply split report identifies the number of actual split orders placed by contract manufacturers (CM) on manufacturers and enables a comparison of the actual split orders to the number of split orders that were planned. The data columns that the report provides may provide include, but are not limited to: the name of the contract manufacturer, the list of P/Ns, manufacturer and manufacturer P/N, projected percentage of split orders estimated by the host, projected percentage of split orders estimated by the corresponding supply chain partner, and the actual quantity of split orders, the actual percentage of split orders, and the actual dollar value of the split orders.

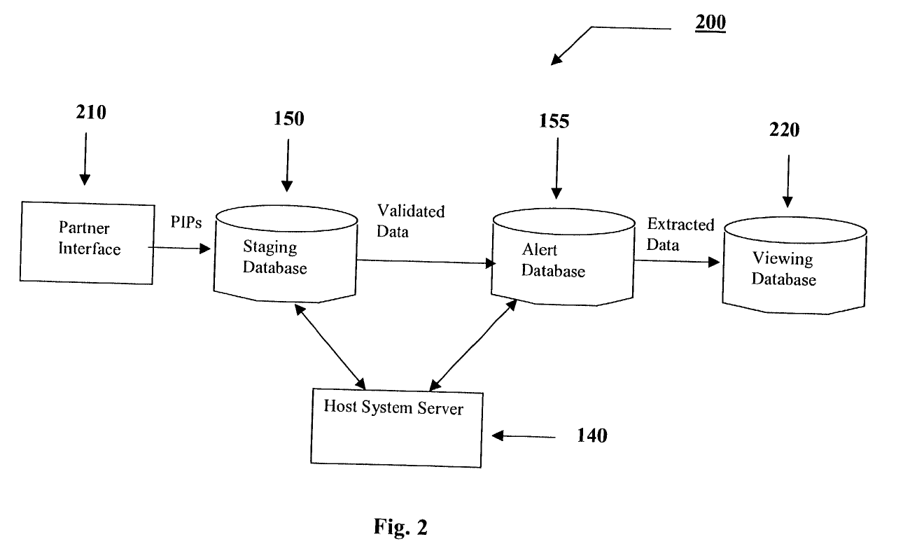

FIG. 2 illustrates the data flow for the configurable electronic business exchange system 100 in accordance with one embodiment of the invention. The supply chain partner interface 210, i.e. user interface 115, 170, or 145 as shown in FIG. 1, transmits partner interface processes (PIPs) to the staging database 150, also shown in FIG. 1. The PIPs reference the data elements that are exchanged with supply chain partners. These data elements may be a subset of the definition of any generic supply chain standard. For example, the data elements may be a subset of the RosettaNet standards, which are standards defined by a committee whose mission is to document business processes and standards as they relate to B2B electronic commerce. The staging database 150 validates the received PIP data to ensure that the data for the business rules conform to the applicable formats and that the defined roles do not violate security standards. After validating the data, the staging database 150 exports the data into the alert database 155, where both rule processing and alert processing can occur. Both the staging database 150 and the alert database 155 are in communication with the host system server 140, also shown in FIG. 1.

The alert database 155 schedules the business rules for a user and/or associated PIP to run on a periodic basis. Alerts are then evaluated as appropriate. If the generated alert is a new alert, then an entry for it is created in an alert table, which is stored in the alert database 155. If the alert was previously created, and therefore already exists in the alert table, then host system server 140, shown in FIG. 1, takes no action concerning the alert. After the buyer 160 or the seller 110, i.e. the user, both shown in FIG. 1, has corrected, or repaired, the basis for an alert, the alert is removed from the alert table. If there are any new alerts that have not been sent to the appropriate user, the host system server 140 then sends the notifications to the appropriate users. The host system server 140 consolidates the alert notifications by business rule for each recipient. The data that accompanies the alert notifications is thus extracted from the alert database and is sent to a viewing database application 220, through which the user 110 is able to sort and view the data using drill down menus.

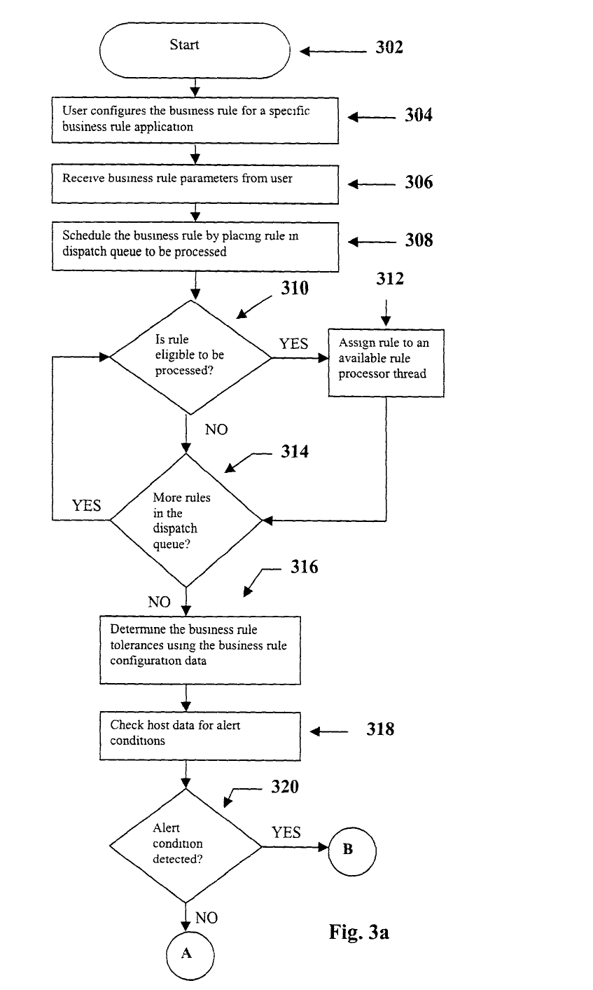

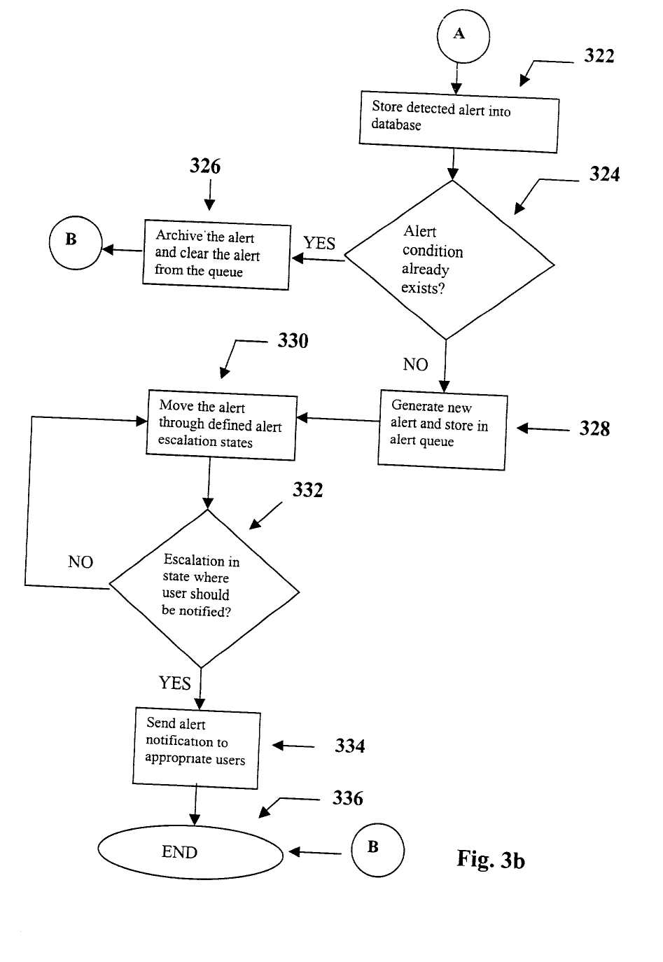

FIGS. 3a-b illustrate a methodology for processing business rules and generating alert notifications in accordance with one embodiment of the invention. The process begins at step 302. In step 304, the user configures the business rule for a specific business rule application by defining the parameters and the tolerances that will be used to process the business rule. A business rule therefore includes properties that specify the criteria and thresholds for the rule. A rule also includes the escalations properties that should be specified for each supply chain partner, i.e., the supplier 110 and/or buyer 160. These properties include the role for which the supply chain partner should receive alerts and after what period the partner should receive them, e.g., one day, one week, etc.

A business rule application is the platform that supports a business rule. It is the software, or hardware, program that defines how the system server should execute a particular type of business rule. In step 306, the system server receives the user-defined business rule parameters.

In step 308, the system server then schedules the business rule by placing the rule in a dispatch queue to be processed before determining, in step 310, whether the business rule is eligible to be processed. A business rule is eligible to be processed if the user has the appropriate authority, or role, to execute the business rule. If the user requesting the server to process the rule does not have the appropriate authority, the process moves to step 314, otherwise the process moves to step 312. In step 312, the system assigns the business rule to an available rule processor thread, before continuing to step 314.

In step 314, the host system server determines whether there are any more business rules remaining in the scheduling queue. If the host system server determines that there are more business rules remaining in the queue, the process returns to step 308. If there are no more business rules remaining in the queue, the process moves to step 316. In step 316, the host system server determines the business rule tolerances using the business rule configuration data. The tolerances of a business rule are the parameters that define the maximum variance in a supply chain variable before an alert notification is generated. For example, if the tolerance of a specific business rule monitoring the delivery of product×is 100 units, and 200 fewer units of product×were shipped than expected, the host system server would generate an alert notification as a result of the shipping discrepancy. The process then proceeds to step 318.

In step 318, the host system server databases are monitored for alert conditions. In step 320, the host system server determines whether an alert condition exists. If an alert condition does exist, the process moves to step 322, otherwise the process moves to step 336, and ends. In step 322, the host system server stores the detected alert conditions into an alert database. In step 324, the host system server determines whether the detected alert condition previously exists. If the detected alert condition does exist, the process continues to 326, otherwise the process moves to 328. In step 326, the previously detected alert is archived in a host system database and then cleared from the alert from the queue. The process then moves to step 336 and ends.

Returning to step 328, the host system server generates a new alert for the detected condition and places the alert in the alert queue for further processing. The process moves to step 330.

In step 330, the host system server moves the alert through defined alert escalation states before generating an alert notification. In addition to the notification process, the system herein allows the host system server to notify buyers and sellers if an exception has not been resolved within a specified period of time. This process is known as escalation and allows the buyers and sellers to define the number of days that may elapse between when an alert notification is created and when the host system server sends the notification to the appropriate buyers and/or supplier. Each time the an alert is moved through an escalation state, the host system server system server examines the amount of time the alert notifications have existed and compares this time with the value in the parameter for the escalation level associated with the appropriate buyer or seller. If the alert notification existed longer than the value of the escalation parameter, notifications are sent to the associated buyers and/or suppliers.

In step 332, the host system server determines whether the escalation parameter is in a state such that the alert notification should be sent to the associated buyers and/or suppliers. If the escalation parameter is in such a state the process moves to step 334, otherwise the process returns to step 330. In step 334, the host system server sends an alert notification to the appropriate buyers and/or suppliers before moving to step 336. The process then concludes in step 336.

In accordance with one embodiment of the invention, the business rules generating alert notifications for violations of the rules follow several different processes that indicate differing violations. For example, the business rule may be defined to identify differences between a buyer's PO delivery date and quantity and the supplier's sales order delivery date and quantity or may be defined to determine whether aggregate demand for a product exceeds the supply of the product during a specified time interval.

According to one embodiment of the invention, the business rule processes available for execution include, but are not limited to: expected delivery disconnect, unplaced PO, late purchase order receipt, late sales order shipment, late trigger start, supply/demand disconnect, baseline forecast disconnect, forecast time disconnect, lead-time disconnect, sales order change, top level demand disconnect, lead time/delivery date disconnect, bill of material disconnect, and MRP reports. For illustrative purposes only, the processes associated with each of the above business rules are discussed below.

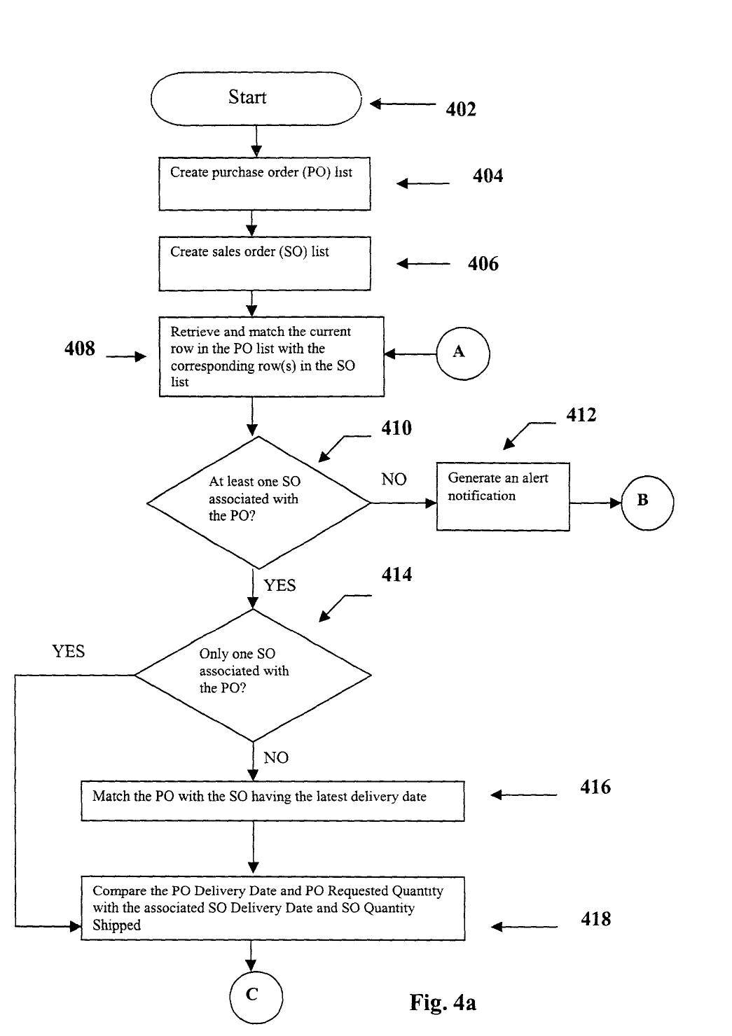

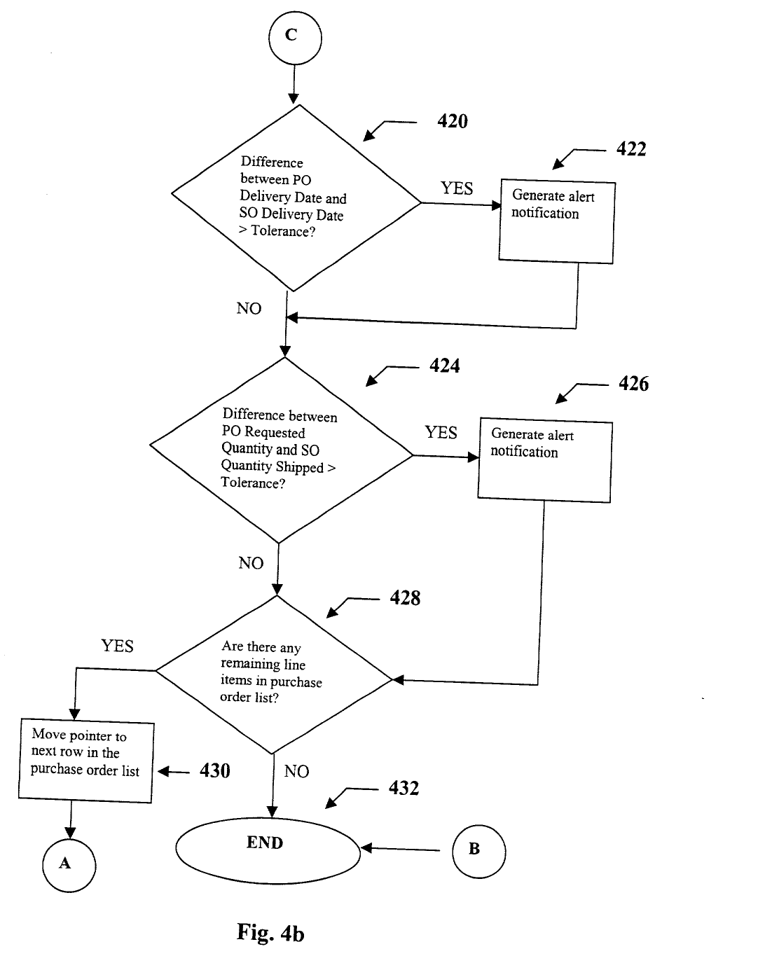

FIGS. 4a-b illustrate the process for identifying an expected delivery disconnect business rule in accordance with one embodiment of the invention. A disconnect occurs when a buy side supply chain partner disagrees with a supply chain partner as to a relevant supply chain parameter, viz., the expected delivery date. The process begins at step 402. In step 404, the host system server runs a query on the PO tables to retrieve distinct PO delivery lines from POs where the buying partner on the PO is the given buying partner. That is, the host creates a file that includes valid PO delivery lines along with the associated PO header and PO line attributes from all the POs issued by the buying partner from whose perspective the disconnect is to be evaluated. A buying partner's PO list therefore contains the data records for each outstanding PO associated with the particular buyer and may be sorted in an ascending order using a sort sequence that includes the following data fields: selling partner, PO number, manufacturing product ID, end user product ID, PO line number, and current delivery date.

In step 406, the host system server retrieves a selling partner's sales order (SO) list to create a list of all the line items associated with a particular partner. That is, only shipments belonging to SOs where the selling partner is the partner from whose perspective the discrepancy is being evaluated will be retrieved. Furthermore, only those shipments that are not cancelled and whose corresponding SO line is active are retrieved. A seller partner's sales order list may therefore contain the data records for each outstanding sales order associated with the particular seller and may be sorted in an ascending order using a sort sequence that includes the following data fields: selling partner, PO number, manufacturing product ID, end user product ID, SO line number, and SO current delivery date.

In step 408, the host system server retrieves the line item, or row, in the PO list corresponding to the value of the line item counter and searches the SO list to determine the number of sales orders that match, or correspond to, the retrieved purchase order. The host system server uses a counter to determine which row to retrieve in the PO list. Initially, this counter is set to a value of 1. Thus, the first time the process executes step 408, the host system server retrieves the first row in the PO list. The host system server determines whether a match exists by comparing key attributes on the SO row(s) with the corresponding attributes in the PO row. Examples of key attributes include delivery date, P/N ordered, units ordered, unit price.

In step 410, the host system server determines whether any SO row(s) correspond to the retrieved PO row. If no SO row(s) are associated with the PO, the process moves to step 412, otherwise the process moves to step 414. In step 412, the host system server generates an alert notification to indicate that no sales orders exist that correspond to the queried PO row. The data fields generated in an alert for this business rule may include the alert generation date, buy-side partner ID, sell-side partner ID, PO number, P/N, P/N descriptions, PO delivery date, PO quantity, PO last updated date, SO number, manufacturer P/N, P/N description, SO delivery date, SO quantity, SO last updated date. The drill down menus available to a supply chain partner receiving this alert may include the ability to search for approved vendor list, buy-side part master, demand pegging, notification history, PO detail, sell-side part master, SO detail, supply/demand profile, and where used data. The process then moves to step 432, where it ends.

In step 414, the host system server determines whether more than one SO is associated with the retrieved PO. If there are more than one SOs associated with the retrieved PO, the process moves to step 416, otherwise the process moves to step 418. In step 416, the host system server matches the PO with the SO having the latest delivery date. The process then moves to step 418.

In step 418, the host system server compares the PO delivery date and PO requested quantity with the associated SO delivery date and the SO quantity shipped. In step 420, the host system server determines whether the difference between the PO delivery date and the SO delivery date is within an acceptable tolerance, which is defined when the business rule is configured. After a buyer issues a PO, the seller is given a grace period within which to respond to the PO with a corresponding SO. Thus, the host system server may determine whether the shipment is too late by determining whether the difference between the buyer's expected delivery date and the seller's delivery date is within the value of the grace period, which may be stored in the variable “sales order delay days variable.”

Conversely, the seller's delivery date is too early if the seller's delivery date precedes the buyer's expected delivery date by an amount greater than the tolerance associated for the business rule. If the SO delivery date is too early or is too late the process moves to step 422, otherwise the process moves to step 424. In step 422, the host system server generates an alert notification indicating the seller's delivery date is either too early or too late. The process then moves to step 424.

In step 424, the host system server determines whether the difference between the quantity requested by the buyer and the quantity to be shipped by the seller is within an acceptable tolerance, which is defined when the business rule is configured. This test may only be valid if the selling partner has not completed all of the shipments associated with the PO. That is, if the selling partner has completed the shipment, the difference will be set to 0, and therefore will be within the configured tolerance.

If the shipment is not complete, however, the host system server will first calculate the sum of the SO remaining quantity of units to be shipped and the quantity of units in transit. The host server will then determine whether this quantity is less than or greater than the PO remaining quantity of units to be received by more than the configured tolerance, which may be stored in the variable “absolute percentage mismatch.” If the difference does exceed the configured tolerance, the process moves to step 426, otherwise the process moves to step 428. In step 426, the host system server generates an alert notification that indicates that the PO requested units and the SO quantity shipped exceed the configured tolerance. The process moves to step 428.

In step 428, the host system server determines whether there are any PO rows in the buying partner's PO list remaining to be evaluated. If there is at least one row remaining to be evaluated, the process moves to step 430, otherwise the process moves to step 432. In step 430, the host system server increments the purchase order line item counter by 1 before returning to step 408 to retrieve the PO row and match it with the corresponding SO row(s) in the SO list. The process moves to step 432, where it ends.

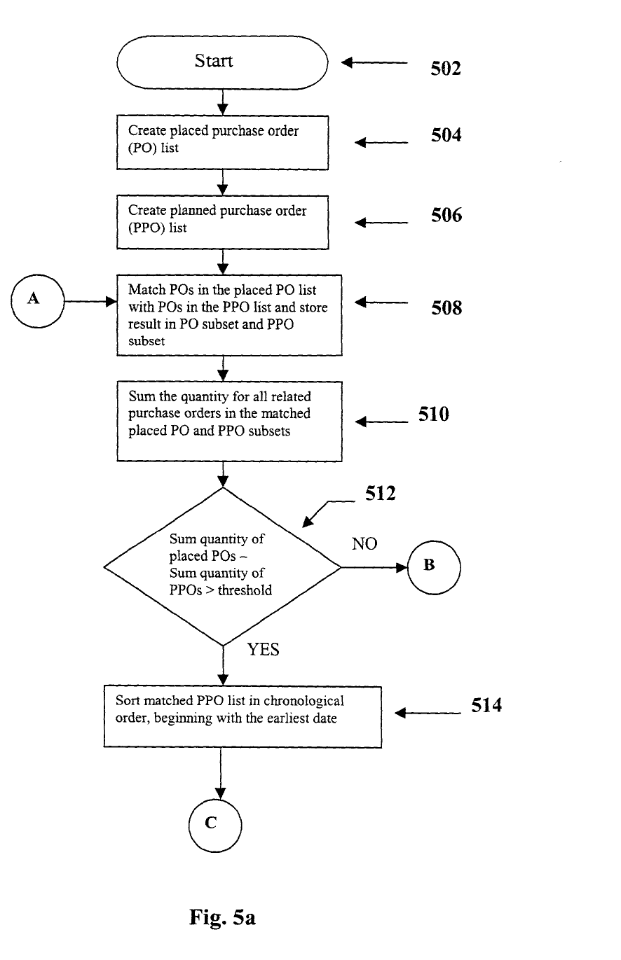

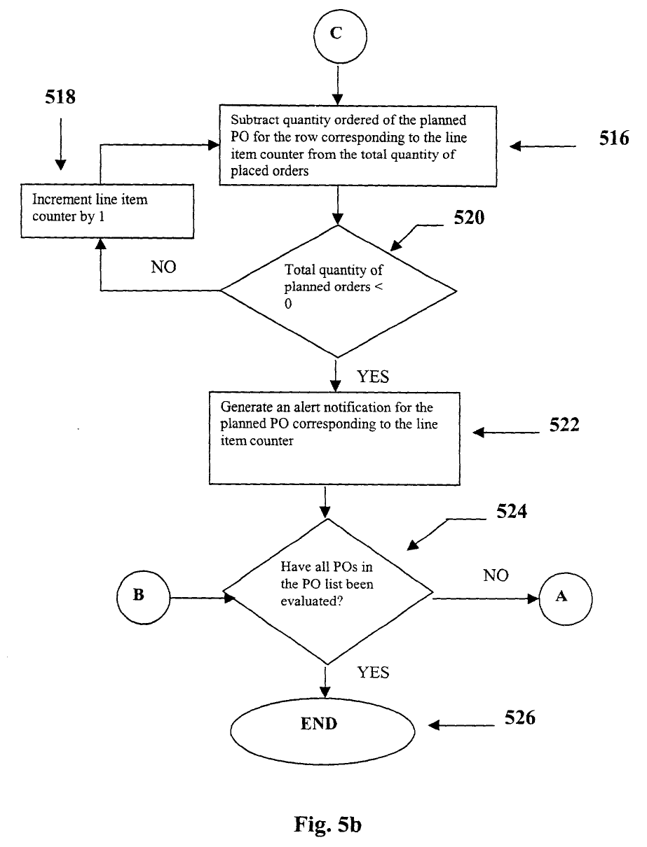

FIGS. 5a-b illustrate the process for identifying an unplaced PO business rule in accordance with one embodiment of the invention. The process begins at step 502. In step 504, the host system server creates a placed purchase order list by running a query on the PO tables to retrieve distinct PO delivery lines from POs where the buying partner on the placed PO is the given buying partner. That is, the host creates a file that includes valid PO delivery lines along with the associated PO header and PO line attributes from all the POs placed by the buying partner from whose perspective the disconnect is to be evaluated. A buying partner's placed PO list therefore contains the data records for each outstanding PO associated with the particular buyer and may be sorted in an ascending order using a sort sequence that includes the following data fields: end user product ID and planning division. This sorting is done to facilitate matching the PO rows in this list with the corresponding PO in the planned purchase order list.

In step 506, the host system server creates a planned purchase order list by running a query on the PO tables to retrieve distinct PO delivery lines from POs where the buying partner on the placed PO is the given buying partner that has required order placement dates in the configured time horizon. The configured time horizon may be defined as the time period between the date of the PO and a period of time in the future from the point. A buying partner's PPO list may therefore contain the data records for the POs that are scheduled to be placed by the configured buying partner in the near future and may be sorted in an ascending order using a sort sequence that includes the following data fields: end user product ID and planning division. This sorting is done to facilitate matching the PO rows in this list with the corresponding PO in the placed purchase order list.

In step 508, the host system server matches the appropriate POs in the placed PO list with the corresponding POs in the PPO list. It does this by creating a placed PO set by including in the set every row in the placed PO list that shares the same values for the planning division that placed the PO and the end user P/N associated with the placed PO. Similarly, the host system server then creates a matching planned PO set by including in the set every row in the PPO list that shares the same values for the planning division that is the subject of the placed POs and the end user P/Ns associated with these POs.

In step 510, the host system server sums the quantities ordered for every PO in the placed PO set and the matching planned PO set. In step 512, the host system server determines whether the sum quantity ordered in the POs in the placed PO set is greater than the sum quantity ordered in the planned PO set plus a threshold margin of error. If the quantity of orders placed exceeds the quantity of planned orders by more than the configured threshold level, the process moves to step 514, otherwise the process moves to step 524. In step 514, the host system server chronologically sorts the purchase orders in the planned PO set, starting with earliest date in time. The process moves to step 516.

In step 516, the host system server reduces the total quantity of units ordered in the placed PO set by the quantity planned to be ordered for the row in the planned PO set corresponding to the current value of the line item counter. The host system server uses a counter to determine which row to use in the planned PO set. Initially, this counter is set to a value of 1. Thus, the first time the process executes step 516, the host system server reduces the total quantity of units ordered by the amount planned to be in the first row of the planned PO set. The process moves to step 520.

In step 520, the host system server determines whether the adjusted total quantity of units ordered is negative. If it is negative, the process moves to step 522, otherwise the process moves to step 518. In step 518, the host system server increments the line item counter by one, before returning again to step 516 to decrease the total quantity ordered by the units to be ordered in the appropriate planned PO.

In step 522, the host system server generates an alert notification for the planned PO row corresponding to the last value of the line item counter. The data fields generated in an alert for this business rule may include the alert generation date, buy-side partner ID, manufacturing resource plan (MRP) run date, P/N, order start date, MRP required delivery date, days late, planned PO quantity, quantity short, quantity short (percent), and look ahead days. The drill down menus available to a supply chain partner receiving this alert may include the ability to search for approved vendor list, buy-side part master, demand pegging, notification history, supply/demand profile and where used data. The process then moves to step 524.

In step 524, the host system server determines whether each PO in the PO list associated with the buying-side partner have been evaluated. If they have been evaluated, the process moves to step 526, otherwise the process returns to step 508. In step 526, the process concludes.

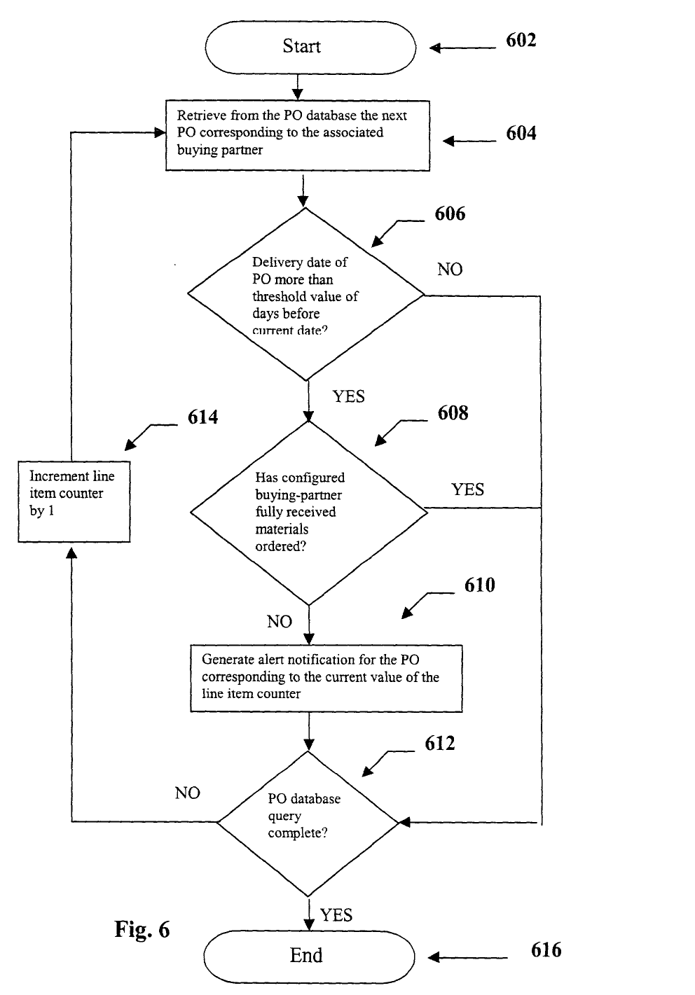

FIG. 6 illustrates the process for identifying late PO receipts business rule in accordance with one embodiment of the invention. The process begins in step 602. In step 604, the host system server retrieves, from the PO database, the PO row of data fields corresponding to the configured or identified buying partner and to the current value of the line item counter. The host system server may use a counter to determine which row to retrieve in the PO database for the query initiated by this process. Initially, this counter is set to a value of 1. Thus, the first time the process executes step 604, the host system server retrieves the first row of data fields from the PO database. The host system server will continue to increment the line item counter until it either finds a row corresponding to the identified buying partner or it reaches the end of the database. The process moves to step 606.

In step 606, the host system server determines whether the delivery date associated with the retrieved PO is more than a configured error threshold value of days before the present date. The error threshold value may be defined during the configuration of the business rule. If the delivery date of the PO is more than the error threshold value of days before the current date, the process moves to step 608, otherwise the process moves to step 612.

In step 608, the host system server determines whether the buying partner has fully received the materials ordered by the retrieved PO. If the buying partner has received the materials, the process moves to step 612, otherwise the process moves to step 610.

In step 610, the host system server generates an alert notification for the PO corresponding to the current value of the line item counter. The data fields generated in an alert for this business rule may include the alert generation date, buy-side partner ID, sell-side partner ID, P/N, P/N description, PO delivery date, remaining quantity due, PO last updated date, SO number, manufacturer P/N, SO delivery date, SO ship date, remaining quantity due, SO last updated date, days late, and max days late. The drill down menus available to a supply chain partner receiving this alert may include the ability to search for approved vendor list, buy-side part master, demand pegging, notification history, PO detail, SO detail, supply/demand profile and where used data. The process then moves to step 612.

In step 612, the host system server determines whether the PO database query has been completed. If the query has been completed the process moves to step 616, otherwise the process moves to step 614. In step 614, the host system server increments the line item counter by 1 before returning to step 604 to retrieve the next associated PO from the PO database. In step 616, the process concludes.

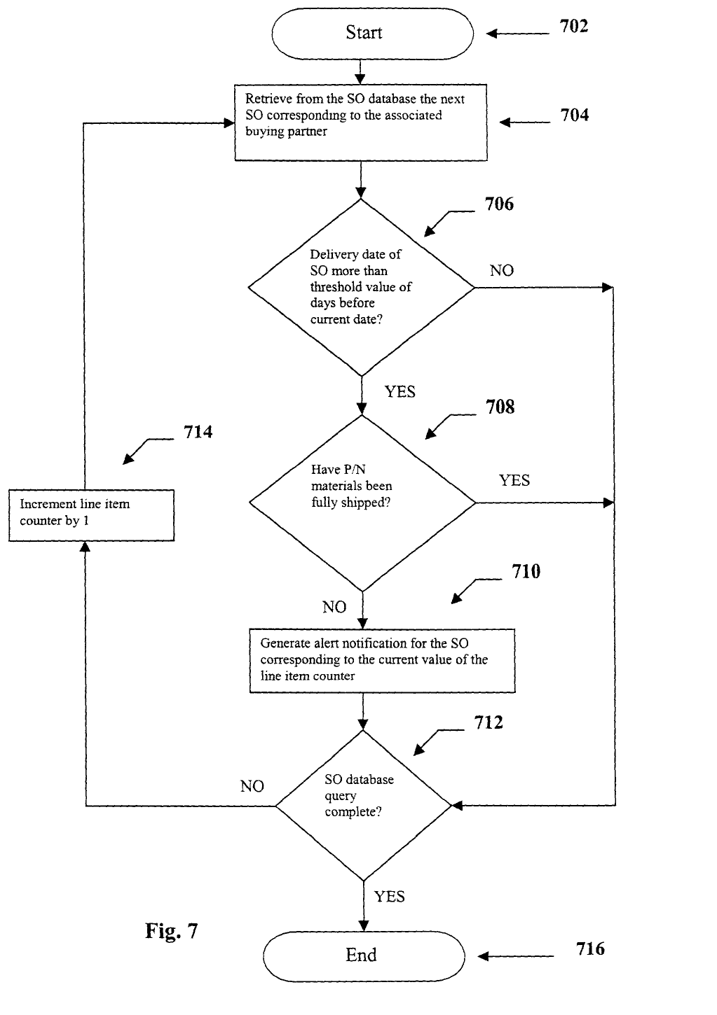

FIG. 7 illustrates the process for identifying late sales order shipments business rule in accordance with one embodiment of the invention. The process begins in step 702. In step 704, the host system server retrieves, from the SO database, the SO row of data fields corresponding to the configured or identified buying partner and to the current value of the line item counter. The host system server may use a counter to determine which row to retrieve in the SO database for the query initiated by this process. Initially, this counter is set to a value of 1. Thus, the first time the process executes step 704, the host system server retrieves the first row of data fields from the SO database. The host system server will continue to increment the line item counter until it either finds a row corresponding to the identified selling partner or it reaches the end of the database. The process moves to step 706.

In step 706, the host system server determines whether the delivery date associated with the retrieved PO is more than a configured error threshold value of days before the present date. The error threshold value may be defined during the configuration of the business rule. If the ship date of the SO is more than the error threshold value of days before the current date, the process moves to step 708, otherwise the process moves to step 712.

In step 708, the host system server examines the SO data to determine whether the P/N materials have been fully shipped. If the P/N materials have been fully shipped the process moves to step 712, otherwise the process moves to step 710.

In step 710, the host system server generates an alert notification for the SO corresponding to the current value of the line item counter. The data fields generated in an alert for this business rule may include the alert generation date, buy-side partner ID, sell-side partner ID, PO number, P/N, P/N description, PO delivery date, remaining quantity due, PO last updated date, SO number, manufacturer P/N, SO delivery date, SO ship date, SO last updated date, days late, and max days late. The drill down menus available to a supply chain partner receiving this alert may include the ability to search for buy-side part master, demand pegging, notification history, PO detail, sell-side part master, SO detail, supply/demand profile and where used data. The process then moves to step 712.

In step 712, the host system server determines whether the SO database query has been completed. If the query has been completed the process moves to step 716, otherwise the process moves to step 714. In step 714, the host system server increments the line item counter by 1 before returning to step 704 to retrieve the next associated PO from the PO database. In step 716, the process concludes.

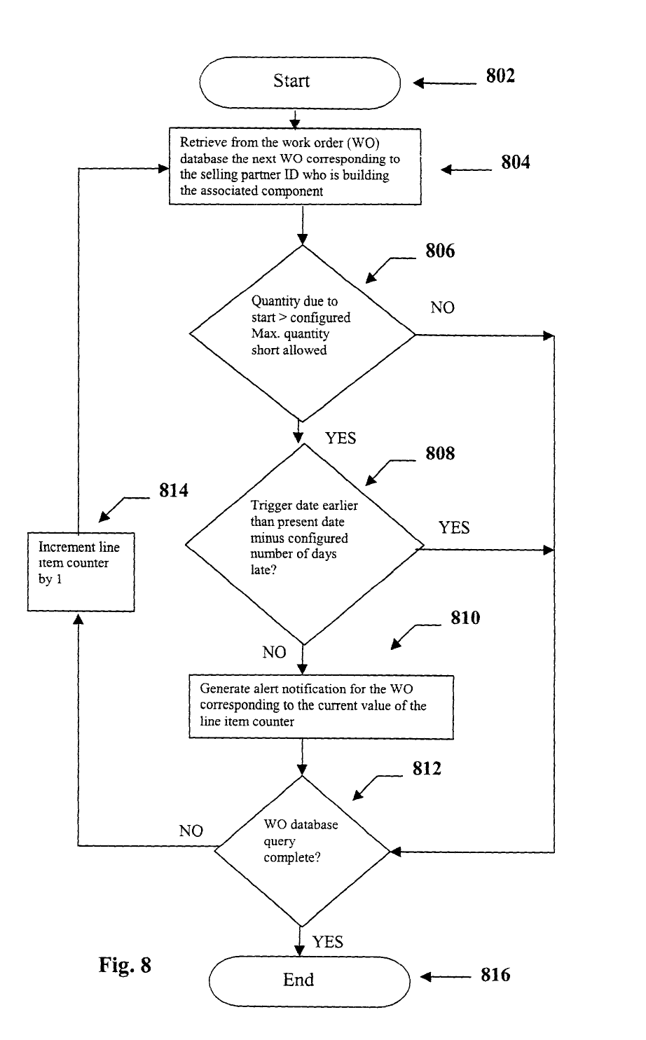

FIG. 8 illustrates the process for identifying late trigger starts business rule in accordance with one embodiment of the invention. A trigger is a partner interface process that is used to communicate replenishment requests to a supply chain partner to ensure that the demand for the product is satisfied by its supply, and may be sent daily. The process begins in step 802. In step 804, the host system server retrieves, from the work order (WO) database, the WO row of data fields corresponding to the configured or identified selling partner who is building the associated component and to the current value of the line item counter. A work order is a partner interface process that is used to communicate a work in process. Shortage and completion detail data should also be included in a work order, which may be sent daily. The retrieved data fields may include the trigger number, the selling partner ID, the building partner ID, the planning division, the end user P/N, the required quantity, the cancelled quantity, the started quantity, and the trigger date. The host system server may use a counter to determine which row to retrieve in the SO database for the query initiated by this process. Initially, this counter is set to a value of 1. Thus, the first time the process executes step 804, the host system server retrieve the first row of data fields from the WO database. The host system server will continue to increment the line item counter until it either finds a row corresponding to the identified selling partner or it reaches the end of the database. The process moves to step 806.

In step 806, the host system server determines whether the quantity due to start is greater than the configured maximum value for the quantity short allowed. The quantity due to start may be defined as the required or ordered quantity minus the sum of the start quantity of units for the trigger and the cancel quantity of units for the trigger. If the quantity due to start is greater than the configured maximum quantity short that is allowed the process moves to step 808, otherwise the process moves to step 812.

In step 808, the host system server examines the WO data fields to determine whether the trigger date is earlier than the present date minus an allowable number of days late. The allowable number of days late may be defined when the business rule is configured. If the trigger date is earlier than the present date minus an allowable number of days late the process moves to step 812, otherwise the process moves to step 810.

In step 810, the host system server generates an alert notification for the WO corresponding to the current value of the line item counter. The data fields generated in an alert for this business rule may include the alert generation date, sell-side partner ID, trigger number, P/N, P/N description, trigger date, remaining quantity due, PO last updated date, SO number, manufacturer P/N, start quantity, cancel quantity, required quantity, quantity due to start, days late, max days late, and max quantity short allowed. The drill down menus available to a supply chain partner receiving this alert may include the ability to search for part master, demand pegging, notification history, supply/demand profile and where used data. The process then moves to step 812.

In step 812, the host system server determines whether the WO database query has been completed. If the query has been completed the process moves to step 816, otherwise the process moves to step 814. In step 814, the host system server increments the line item counter by 1 before returning to step 804 to retrieve the next associated PO from the PO database. In step 816, the process concludes.

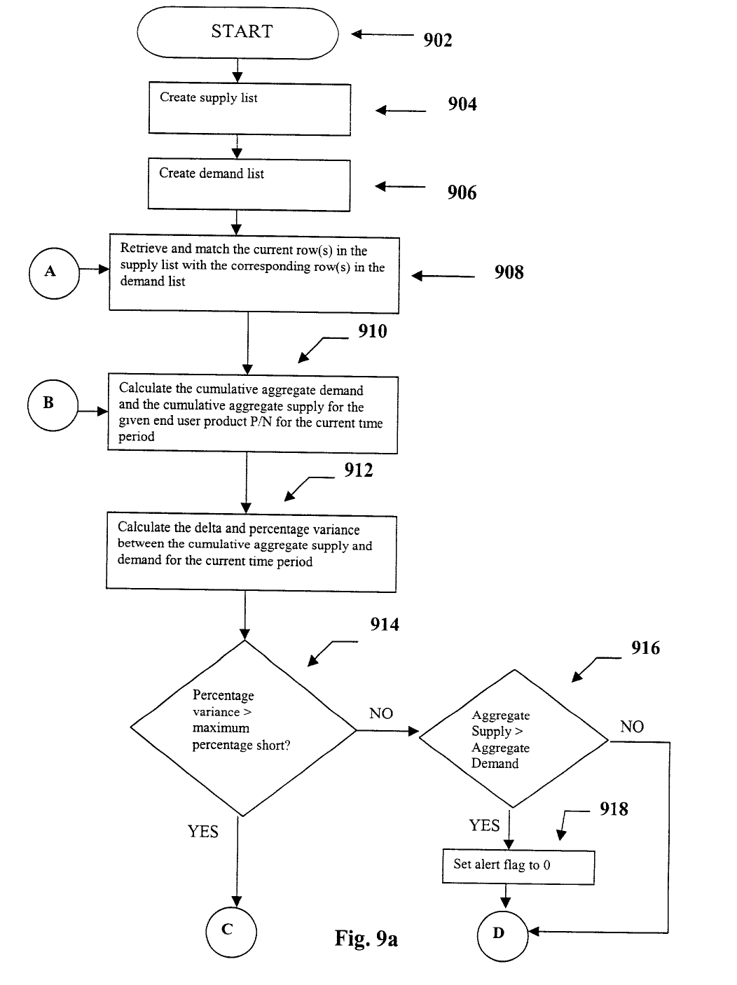

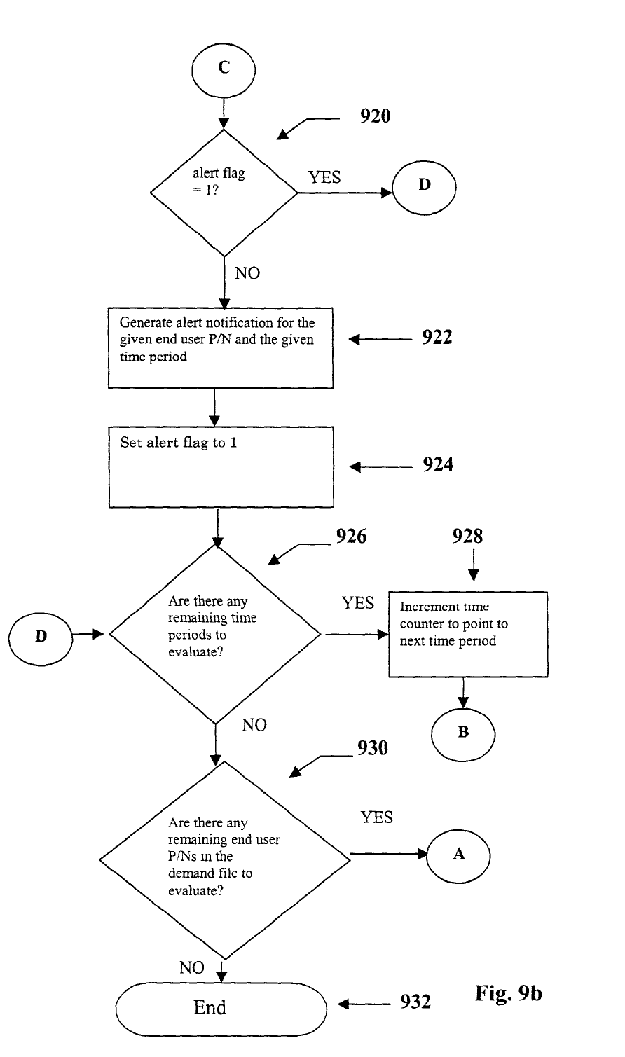

FIGS. 9a-b illustrate the process for identifying a supply demand disconnect business rule in accordance with one embodiment of the invention. This process identifies when a supply chain partner's gross component demand exceeds its supply over the course of a planning period. The process begins in step 902. In step 904, the host system server queries the relevant databases to construct a list, for a specified trading partner, of the partner's gross total supply per part over a specified time period. In step 906, the host system server queries the relevant databases to construct a list, for the same trading partner, of the partner's gross total demand per part over a specified time period.

In step 908, the host system server retrieves and matches the current row(s) of supply data in the supply list with the corresponding row(s) of demand data in the data list. In step 910, the host system server calculates the aggregate demand for a particular P/N at a specific point in time by adding the prior value for the aggregate demand to the sum total of the demand corresponding to the row entries in the specified partner's demand list that are associated with the given P/N and the relevant point in time. Similarly, the host system server calculates the aggregate supply for a particular P/N at a specific point in time by adding the prior value for the aggregate supply to the sum total of the supply corresponding to the row entries in the specified partner's demand list that are associated with the given P/N and the relevant point in time. The process moves to step 912.

In step 912, the host system server calculates the difference between the calculated values for the aggregate demand and the aggregate supply for the given P/N and the specified point in time. Similarly, the host system server also determines the percentage variance between these values. In step 914, the host system server determines whether the calculated value of the percentage variance is greater than the allowable configured error, which may be represented by the variable “maximum percentage short.” If the percentage variance is greater than the allowable error, the process moves to step 920, otherwise the process moves to step 916.

In step 920, the host system server checks to see whether the alert flag has been set to 1. If the value has been set to 1, the process moves to step 926, otherwise the process moves to step 922. In step 922, the host system server generates an alert notification for the given end user P/N and the given time period as a result of the error threshold having been exceeded. The data fields generated in an alert for this business rule may include the alert generation date, supply-chain partner ID, MRP plan date, planned orders in lead time, planned orders between lead time and lead time+4 weeks, number of supply/demand disconnects in lead times, number of supply/demand disconnects between lead time and lead time+4 weeks, PO's that need to be pulled in, PO's that need to be pushed out, relative baseline forecast disconnect totals, lead time baseline forecast disconnect totals, fixed baseline forecast disconnect totals, and forecast time fence disconnect summary.

In step 924, the host system server sets an alert flag to 1 to indicate that the trading partner's gross component demand has exceeded its supply at the specified point in time. The host system server may generate an alert notification for the first period in which the percentage variance exceeds the configured value for the maximum percentage short. For subsequent successive periods during which the trading partner's demand exceeds its supply, the host system server does not reissue an alert. The flag serves as an indicator that the maximum variance has been exceeded without the component supply at least equaling the component demand since the variance was exceeded. The process moves to step 926.

In step 916, the host system server determines whether the aggregate supply exceeds the aggregate demand for the given end user P/N. If it does, the process moves to step 918, otherwise the process moves to step 926. In step 918, the host system server resets the alert flag to 0 to indicate that the aggregate supply presently is greater than the aggregate demand. The process moves to step 926.

Returning to step 926, the host system server determines whether any time period remains to be evaluated. If there are remaining time periods to be evaluated, the process moves to step 928, otherwise the step 930. In step 928, the host system server increments the time counter to point to next time record(s) in the supply and demand lists before returning to step 910 to calculate the cumulative aggregate supply as well as the cumulative aggregate demand.

In step 930, the host system server determines whether there are any end user P/Ns in the demand file remaining to be evaluated. The process concludes at step 932.

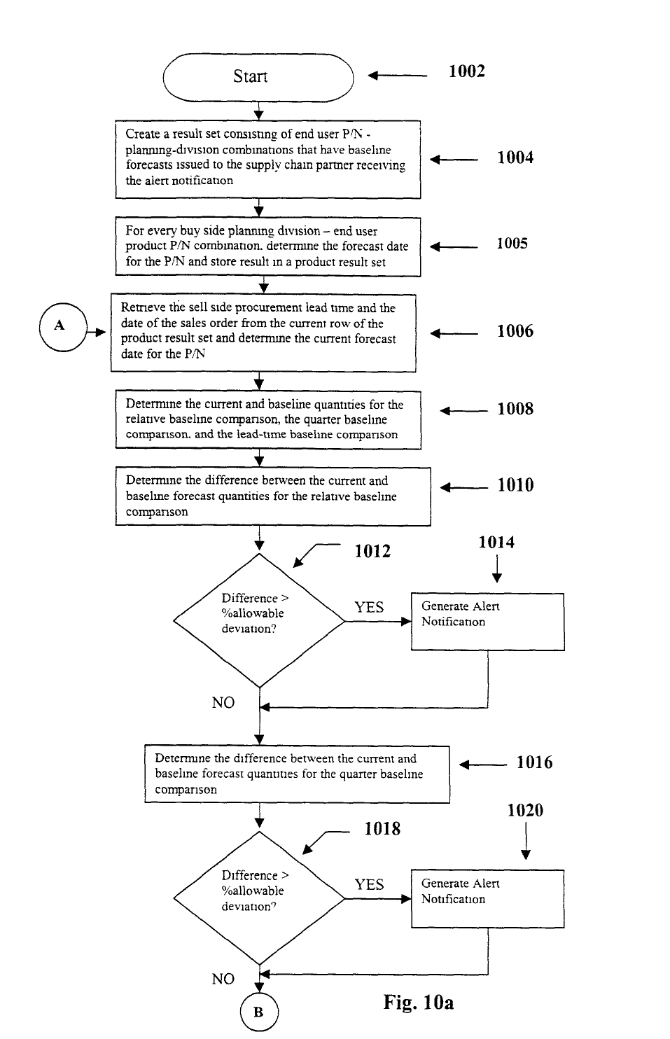

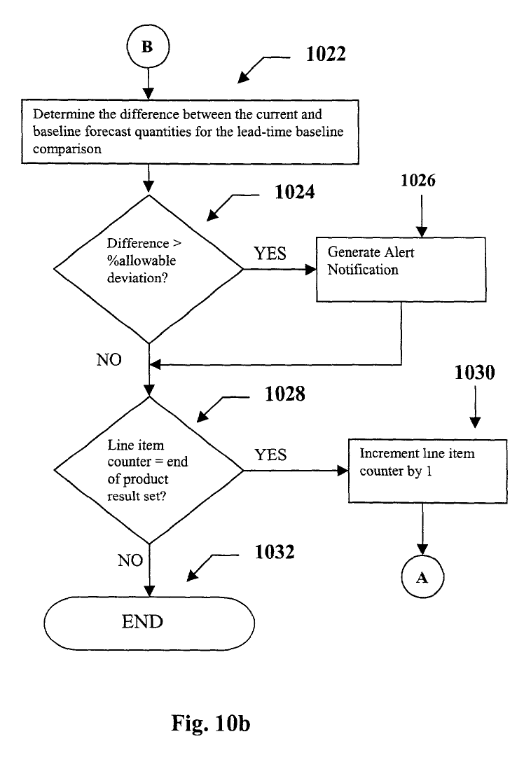

FIGS. 10a-b illustrate the process for identifying a baseline disconnect business rule in accordance with one embodiment of the invention. This process identifies the difference between a buy side partner's baseline forecast and the partner's current week's forecast, and may be accomplished through a comparison of the current week's forecast against the baseline for the configured time horizon, which is used to calculate the cumulative totals for the specified time period. The first period in which the first configured threshold values are exceeded is then identified.

The process begins in step 1002. In step 1004, the host system server creates a result set consisting of combinations of end users P/Ns and planning-division that have baseline forecasts issued to the supply chain partner receiving the alert notification. This result set is a list of product P/N—planning division combinations for which there is at least one forecast in the forecast history tables and the history tables where the product-planning division combination where the host is identified as the sending supply chain partner and the receiving partner is the “receiving partner input.” A product P/N—planning division combination is a row in the PO data files that has a specified planning division as the purchasing entity for a specific end user P/N.

In step 1005, the host system server creates the product result set by determining the current forecast date for each of the buy side planning division—end user product P/N combinations in the result set. A buy side planning division—end user product P/N combination is a row in the PO data files that has a specified planning division of the buying supply chain participant as the purchasing entity for a specific end user product P/N. The product result set may have several rows. Each row includes, but is not limited to the following data fields: buy side planning division, end user product P/N, sell procurement lead time for the corresponding end user product P/N, and the current date associated with the corresponding buy side planning division—end user product P/N combination.

In step 1006, the host system server searches the row in the product result set corresponding to the value of the line item counter used to parse the set. Therefore, the first time that the host system server executes step 1006 the line item counter is 1 and the host system server reads from the first row of the product result set. The host system server retrieves the sell side procurement lead time and the current date associated with the sales order for the end user P/N from the product result set and calculates the current forecast associated with this row by adding the sell side procurement lead time to the current date associated with the order.

In step 1008, the host system server determines the current and baseline forecast quantities for the relative baseline comparison, the lead-time baseline comparison, and the quarter baseline comparison.

For the relative baseline comparison, the current quantity associated with the selected row of the product result set is determined by adding the sum of the blanket PO, standard PO and purchase agreement (PA) receipts to the forecast quantity associated with the first period from the current forecast. The sum of the blanket PO, standard PO and PA receipts may be the sum of all the received quantities on all purchase orders and purchase agreements that have received dates within the range of the current forecast date to seven days prior to the current forecast date. However, any time horizon could be used over which these quantities are summed. The forecast quantity may be the sum of all forecasted quantities of the specific end user P/N requested by the specified planning division in the product result set to be received within the range of the current forecast date to seven days after this date. The baseline forecast quantity for the relative baseline comparison may then be determined by summing the forecast quantities for all relative baseline forecasts for all periods within the range of the current forecast date and one week prior to the current forecast date. However, any time period could be used as the relevant time horizon for this calculation.

For the quarter baseline comparison, the host system server must first determine the appropriate quarter baseline date before calculating the current and baseline quantities associated with the baseline comparison. The quarter baseline date may be determined as the Monday corresponding to the second full week that is within the quarter in which the current forecast falls. If the current forecast date is before the Monday corresponding to the second full week that falls in the quarter in which the current forecast date falls, the quarter baseline date is defined as the Monday corresponding to the second full week that falls in the previous week.

The current quantity for the quarter baseline comparison associated with the selected row of the product result set is then determined by adding the sum of the blanket PO, standard PO and purchase agreement (PA) receipts to the forecast quantity associated with the first period from the current forecast. The sum of the blanket PO, standard PO and PA receipts may be the sum of all the received quantities on all purchase orders and purchase agreements that have received dates within the range of the current forecast date and the quarter baseline date. The forecast quantity may be the sum of all forecasted quantities of the specific end user P/N requested by the specified planning division in the product result set within the range of the current forecast date to seven days after this date. The baseline forecast quantity for the quarter baseline comparison may then be determined by summing the forecast quantities for all quarter baseline forecasts for all periods within the range of the current forecast date and one week prior to the current forecast date. However, any time period could be used as the relevant time horizon for this calculation.

For the lead-time baseline comparison, the host system server must first determine the appropriate quarter baseline date before calculating the current and baseline quantities associated with the baseline comparison. The quarter baseline date may be determined as the sell side procurement lead-time for the end user product P/N. The lead-time is the estimated time needed to ship the materials to a warehouse after the order has been received. That is, this time is the ordering time plus and estimated or actual transit time. Because the a sell side partner may have multiple planning divisions, each having its own procurement lead time, the lead-time associated with the smallest planning division may be used as an estimate for the procurement lead times for the other planning divisions. This lead-time may later be used to determine the lag associated with the lead-time baseline. If the lead-time for this planning division is unknown or undefined, a lead-time estimate of zero may be used.

The current quantity for the lead-time baseline comparison associated with the selected row of the product result set is then determined by adding the sum of the blanket PO, standard PO and purchase agreement (PA) receipts to the forecast quantity associated with the first period from the current forecast. The sum of the blanket PO, standard PO and PA receipts may be the sum of all the received quantities on all purchase orders and purchase agreements that have received dates within the range of the current forecast date and the specified lead-time number of days prior to the forecast date. The forecast quantity may be the sum of all forecasted quantities of the specific end user P/N requested by the specified planning division in the product result set within the range of the current forecast date to seven days after this date. The baseline forecast quantity for the lead-time baseline comparison may then be determined by summing the forecast quantities for all lead-time baseline forecasts for all periods within the range of the current forecast date and the specified lead-time number of days prior to the forecast date. However, any time period could be used as the relevant time horizon for this calculation. The process moves to step 1010.

In step 1010, the host system server determines the difference between the current and baseline quantities for the relative baseline comparison. In step 1012, the host system server determines whether the difference between the current and baseline quantities exceeds a percentage allowable deviation. If the difference exceeds the percentage allowable deviation the process moves to step 1014, otherwise the process proceeds to step 1016.

In step 1014, the host system server generates an alert notification to indicate the baseline forecast disconnect as a result of the error threshold having been exceeded. The data fields generated in an alert for this business rule may include the alert generation date, supply-chain partner ID, plan date, host P/N, period of first disconnect, cumulative forecast quantity, cumulative relative baseline quantity, cumulative lead time baseline quantity, cumulative fixed baseline quantity, relative baseline cumulative percentage change, lead time baseline cumulative percent change, fixed baseline cumulative percent change, allowed percent change, partner horizon, relative baseline date, lead time date, fixed forecast date, upper bound cumulative percent change, and the lower bound cumulative percent change. The drill down menus available to a supply chain partner include buy-side part master, forecast waterfall, notification history, and where used. The process moves to step 1016.

In step 1016, the host system server determines the difference between the current and baseline quantities for the quarter baseline comparison. In step 1018, the host system server determines whether the difference between the current and baseline quantities exceeds a percentage allowable deviation. If the difference exceeds the percentage allowable deviation the process moves to step 1020, otherwise the process proceeds to step 1022.

In step 1020, the host system server generates an alert notification to indicate the baseline forecast disconnect as a result of the error threshold having been exceeded. The data fields generated in an alert for this business rule may include the alert generation date, supply-chain partner ID, plan date, host P/N, period of first disconnect, cumulative forecast quantity, cumulative relative baseline quantity, cumulative lead time baseline quantity, cumulative fixed baseline quantity, relative baseline cumulative percentage change, lead time baseline cumulative percent change, fixed baseline cumulative percent change, allowed percent change, partner horizon, relative baseline date, lead time date, fixed forecast date, upper bound cumulative percent change, and the lower bound cumulative percent change. The drill down menus available to a supply chain partner include buy-side part master, forecast waterfall, notification history, and where used. The process moves to step 1022.

In step 1022, the host system server determines the difference between the current and baseline quantities for the lead-time baseline comparison. In step 1024, the host system server determines whether the difference between the current and baseline quantities exceeds a percentage allowable deviation. If the difference exceeds the percentage allowable deviation the process moves to step 1026, otherwise the process proceeds to step 1028.

In step 1026, the host system server generates an alert notification to indicate the baseline forecast disconnect as a result of the error threshold having been exceeded. The data fields generated in an alert for this business rule may include the alert generation date, supply-chain partner ID, plan date, host P/N, period of first disconnect, cumulative forecast quantity, cumulative relative baseline quantity, cumulative lead time baseline quantity, cumulative fixed baseline quantity, relative baseline cumulative percentage change, lead time baseline cumulative percent change, fixed baseline cumulative percent change, allowed percent change, partner horizon, relative baseline date, lead time date, fixed forecast date, upper bound cumulative percent change, and the lower bound cumulative percent change. The drill down menus available to a supply chain partner include buy-side part master, forecast waterfall, notification history, and where used. The process moves to step 1028.

In step 1028, the host system server determines whether it has reached the end of the product result set. It may do this by comparing the value of the line item counter to the number of rows in the set. If the line item counter is less than the number of rows in the product result set, the process moves to step 1030 where the host system server increments the line item counter by 1 before returning again to step 1006. Otherwise, the process moves to step 1032 and concludes.

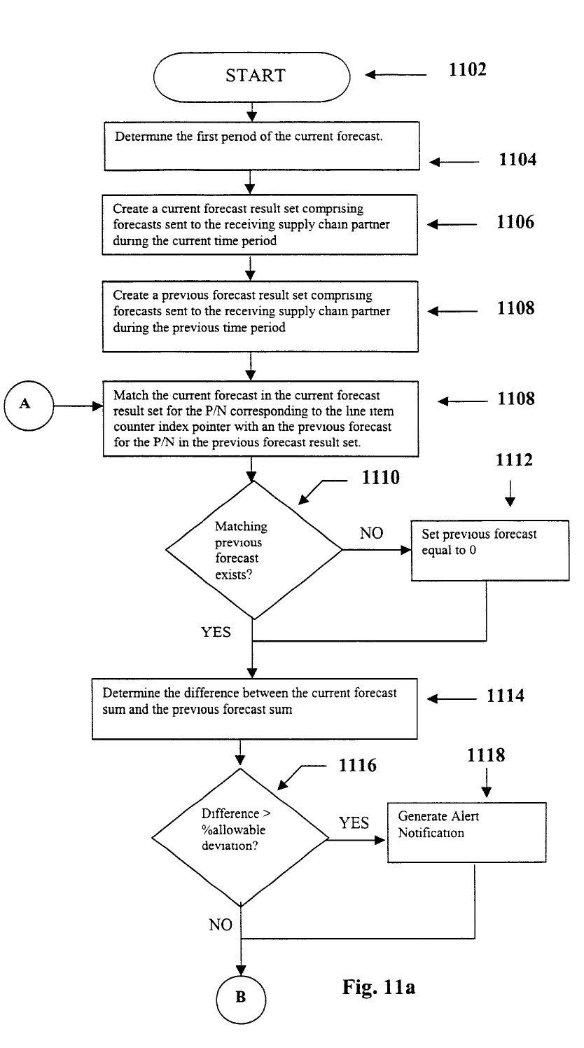

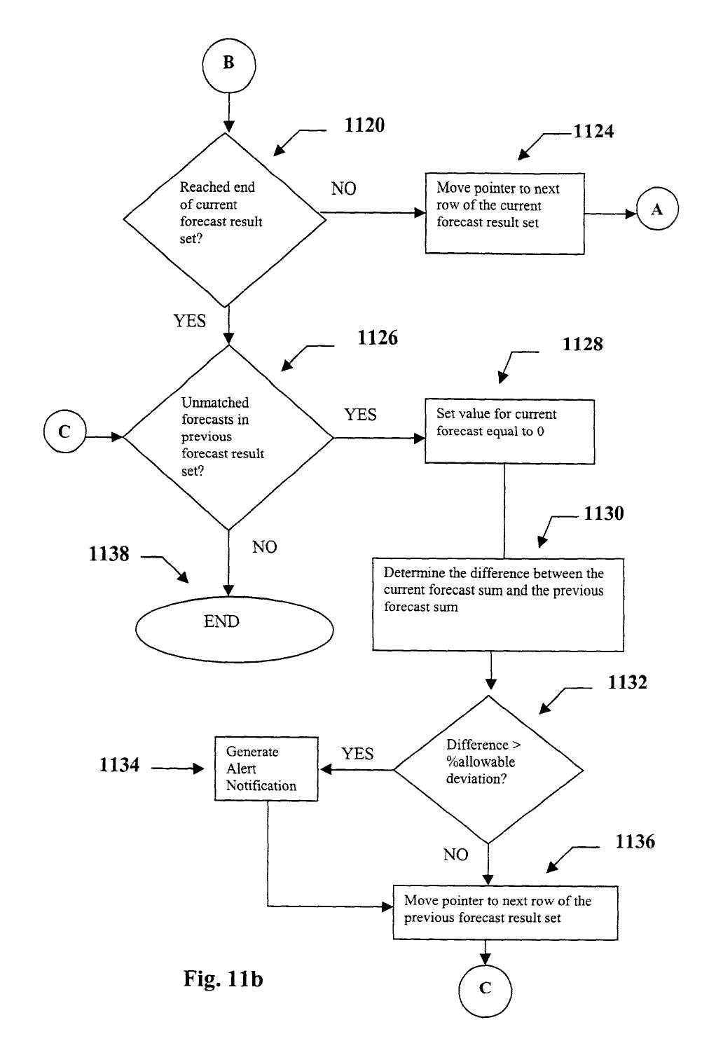

FIGS. 11a-b illustrate the process for identifying a forecast time fence disconnect business rule in accordance with one embodiment of the invention. This business rule identifies any difference between the host's current forecast and the previous week's forecast against the associated supply chain partner's time fence agreement. A time fence defines for a supply chain partner's forecast the start period, the end period, and the allowed percentage change for that time bracket. These variables may be configured from the supply chain partner receiving an alert notification, which may be the sell side perspective. Thus, the forecast time fence disconnect business rule compares the current week's forecast against the previous week's forecast and generates an alert notification when the difference between the cumulative totals defined for the supply chain partner's time fence exceeds the configured maximum allowable percentage change for that time fence.

The process begins in step 1102. In step 1104, the host system server determines the start and end dates of the first period of the current forecast period. The end date of the current forecast period may be defined from the start date plus a function of the number of time fences configured in the business rule. In step 1104, the host system server creates a current forecast result set that is comprised of forecasts received during the current forecast period by the supply chain partner that is configured to receive the alert notifications generated by this business rule. Thus, the current forecast result set may consist of multiple forecast rows detailing the collection data associated with each forecast in the set. The forecast rows may include, but are not limited to, the following data fields: end user product ID, supply chain partner ID that sent the forecast, the planning division of this supply chain partner, and the period start date.

In step 1106, the host system server creates a previous forecast result set that is comprised of forecasts received during the previous forecast period by the supply chain partner that is configured to received the alert notifications generated by this business rule. In step 1108, the host system server attempts to match the forecast in the current forecast result set with a corresponding row in the previous forecast result set. The host system server accomplishes this by determining whether a match exists between the two forecasts on key attributes. These attributes may include the end user product P/N, the from partner ID, and the planning division in the from partner that issued the forecast. In step 1110, the host system server determines whether it was able to match a current forecast with a previous forecast. If it was able to match the two forecasts, the process moves to step 1114, otherwise the process moves to step 1112. In step 1112, the value of the previous forecast sum is set to 0 to reflect that a corresponding previous forecast does not exist. The process moves to step 1114.

In step 1114, the host system server determines the difference between the current forecast sum and the previous forecast sum. In step 1116, the host system server determines whether the absolute value of this sum is greater than the configured allowable percentage deviation. If the difference is greater than the allowable percentage deviation then the process moves to step 1118, otherwise the process moves to step 1120.

In step 1118, the host system server generates an alert notification to indicate the forecast time fence disconnect as a result of the error threshold having been exceeded. The data fields generated in an alert for this business rule may include the alert generation date, supply-chain partner ID, plan date, host P/N, time fence start period, time fence end period, duration, number of periods, previous value, current value, change, percent change, allowed percentage change, partner time fence profile, upper bound cumulative percent change, and the lower bound cumulative percent change. The drill down menus available to the supply chain partner receiving this alert include forecast waterfall, host part master, notification history, and where used. The process moves to step 1120.

In step 1120, the host system server determines whether it has reached the end of the current forecast result set. If it has reached the end of the result set, the process moves to step 1126, otherwise it moves to step 1124. In step 1124, the host system server moves the set pointer to the next row in the current forecast result set before returning to step 1108.

In step 1126, the host system server determines whether all of the previous forecasts in the previous forecast result set were matched with corresponding forecasts in the current forecast result set. If there any previous forecasts that were unmatched to a corresponding current forecast, the process moves to step 1128, otherwise the process moves to step 1138, and ends.

In step 1128, the host system server sets the value of the current forecast sum to 0. This forecast sum will be matched to the unmatched previous forecast and indicates that a corresponding current forecast does not exist. In step 1130, the host system server determines the difference between the current forecast sum and the previous forecast sum. In step 1132, the host system server determines whether the absolute value of this sum is greater than the configured allowable percentage deviation. If the difference is greater than the allowable percentage deviation then the process moves to step 1134, otherwise the process moves to step 1136. In step 1134, the host system server generates an alert notification to indicate that the threshold maximum percentage deviation was exceeded. In step 1136, the host system server moves the pointer to the next row of the previous forecast result set before returning to step 1126.

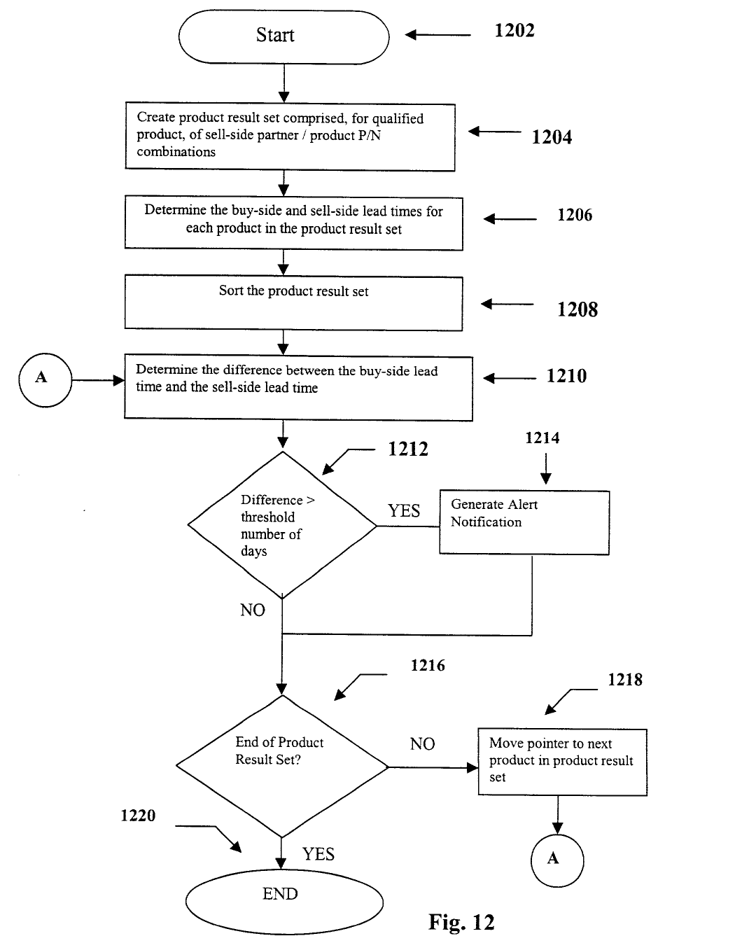

FIGS. 12a-b illustrate the process for identifying a lead time disconnect business rule in accordance with one embodiment of the invention. This business rule identifies differences in lead times between a buy-side partner and a sell-side partner. The host system server executes this rule by comparing the buy-side partner's lead time against a corresponding sell-side partner's lead time for a given P/N. That is, the objective of this rule is to compare the lead times of the buy-side partner for various products with the lead times of sell-side partners that are qualified on the buy-side partners approved vendor list. An alert notification is generated if the lead time is different for the two partners. If a primary supplier is indicated during the configuration of the business rule, the host system server will use its lead time as the sell-side partner's lead time. If there are multiple suppliers, however, the host system server uses the supplier with the longest lead time.

The process begins in step 1202. In step 1204, the host system server creates a product result set that may include a sell-side partner/product P/N combinations. To facilitate the execution of this rule, the host system server limits the size of the product result set by placing only qualified products in the product result set. The host system server may do this by searching the product master list and retrieving the products that are on the buy side partner's approved vendor list and that have a positive gross demand in at least one future period as determined by the most recent execution of the manufacturing resource forecast plan.

In step 1206, the host system server determines the buy-side and sell-side lead times for each product in the product result set. The host system server may do this by looking up each lead-time in the product master list for each product in the result set. In step 1208, the host system server sorts the product result time to facilitate processing of the result set. The product result set may be sorted by the following attributes: first on buy-side product P/N, then on the planning division that ordered the product, and then on the sell-side lead time.

In step 1210, the host system server determines the difference between the buy-side lead time and the sell-side lead time. In step 1212, the host system server determines whether the absolute value of this difference exceeds the configured threshold number of days. If the absolute value of the difference exceeds the threshold value, the process moves to step 1214, otherwise the process moves to step 1216. In step 1214, the host system server generates an alert notification to indicate that the threshold maximum number of days has been exceeded. It may be possible that multiple entries in the product result set for a given buy side planning division/buy-side product combination have lead-time differences that satisfy this condition. In such a case, the host system server generates an alert for the entry that has the greatest lead-time difference. If the multiple entries have the same difference, the host system server generates an alert for each entry. The data fields generated in an alert for this business rule may include the alert generation date, buy-side partner ID, host P/N, P/N description, lead time, manufacturer P/N, lead time, delta number of days, and threshold number of days. The drill down menus available to the supply chain partner receiving this alert include buy-side part master, notification history, sell-side part master, and where used data. The process moves to step 1216.

In step 1216, the host system server determines whether it has reached the end of the product result set. If it has, the process moves to step 1220, and ends. Otherwise, the process moves to step 1218. In step 1218, the host system server moves the pointer to the next product entry in the product result set before returning to step 1210 to determine the difference in the buy-side and sell-side lead times for the next product entry.

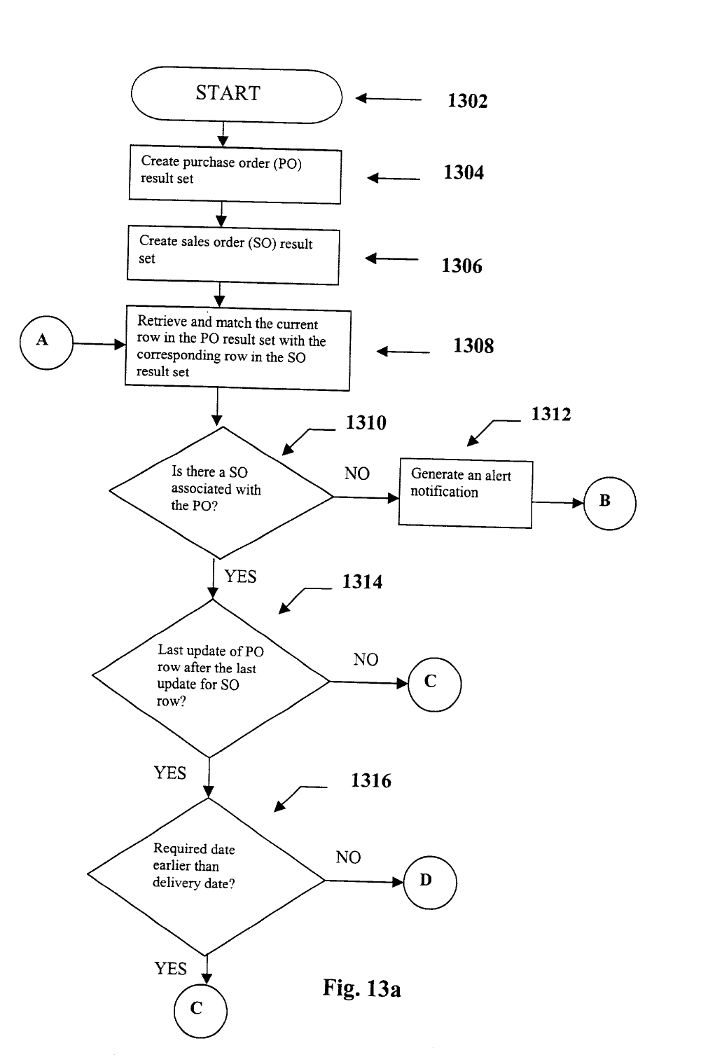

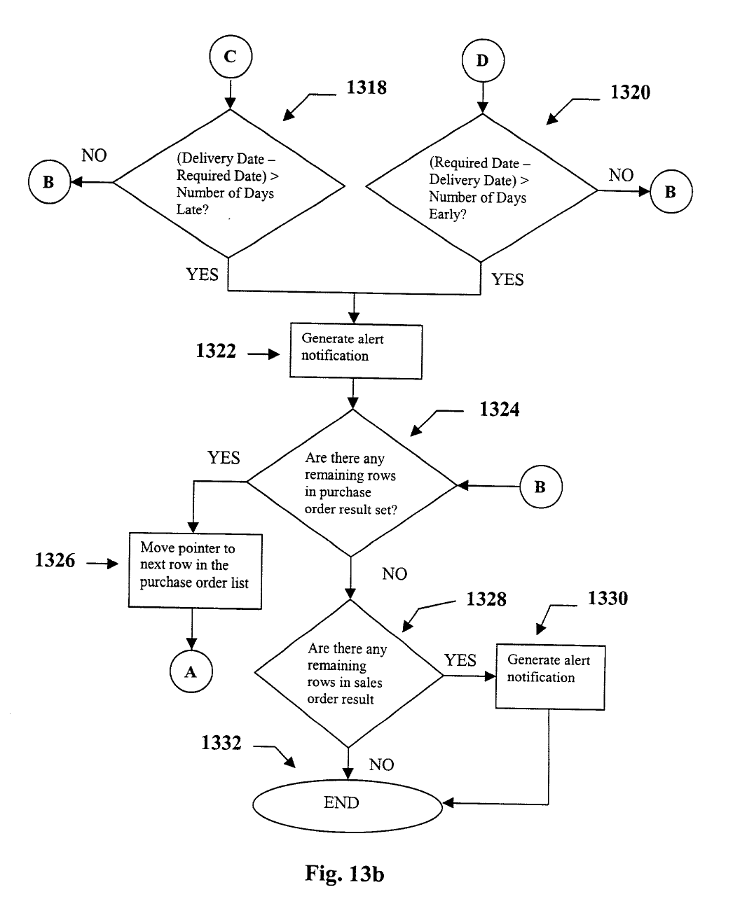

FIGS. 13a-b illustrate the process for identifying a sales order change business rule in accordance with one embodiment of the invention. This business rule identifies purchase orders that are changing and therefore will affect current sales orders. To accomplish this the host system server compares changes to the purchase order need date within the configured time horizon and determines whether, given the new required date, the absolute value of the difference between the scheduled delivery date and the new required date exceeds the configured maximum threshold variance. If the difference exceeds the maximum threshold variance, the host system server generates an alert notification.

The process begins in step 1302. In step 1304, the host system server creates a purchase order result set. The host system server may accomplish this by issuing a query to the purchase order database that returns unique and valid PO delivery lines, as well as the POs issued to the supply chain partner from whose perspective the business rule is executed. The result set of this search may then be sorted in ascending order using a sort sequence comprising, but not limited to, the following attributes: buying partner ID, selling partner, PO number, manufacturing product P/N, end user product P/N, PO line number, and current delivery date. The PO result set is this sorted result of the initial query. If there are more than one delivery lines associated with the same PO and PO line number that have the same current delivery date, the quantities on all such delivery lines may be added to ensure that the PO result set includes only one row with aggregate quantities for a delivery of a specific P/N on a specific date. The process moves to step 1306.

In step 1306, the host system server creates a sales order result set. The host system server may accomplish this by issuing a query to the sales order database that returns unique and valid SO shipment lines, as well as associated SO header and SO line attributes from all the SOs issued by the selling partner from whose perspective the rule is executed. This result set of this search may then be sorted in ascending order using a sort that includes, but is not limited to, the following attributes: buying partner, selling partner, purchase order number, manufacturing product P/N, end user P/N, PO line number, and SO current delivery date. The SO result set is this sorted result of the initial query. If there are more than one shipment lines associated with the same SO and SO line number that have the same current delivery date and Product P/N, the quantities on all such shipment lines may be added to ensure that the SO result set includes only one row with aggregate quantities for a shipment of a specific P/N on a specific date. The process moves to 1308.

In step 1308, the host system server retrieves the purchase order data from the row in the PO result set to which the index pointer is referencing and attempts to match this PO with a corresponding SO in the SO result set. The host system server implements this matching step iteratively, processing a new pair of PO/SO combinations in each iteration to determine whether a match exists between the PO row and the SO row. In step 1308, the host system determines whether a SO exists in the SO result set that matches the PO in the PO result set to which the pointer is currently referencing. If no SO matches the PO the process moves to step 1312, otherwise the process moves to step 1314.

In step 1312, the host system server generates an alert notification to indicate a missing SO. The process then moves to step 1324. In step 1314, the host system server retrieves the last update information for the matching PO and SO rows. It then determines whether the last update of the PO row occurred after the last update of the matching SO row. If the last PO update occurred after the last SO update then the process moves to step 1316, otherwise the process moves to step 1318. In step 1316, the host system server determines whether the required date is earlier than the delivery date. If the required date is earlier than the delivery date the process moves to step 1318, otherwise the process moves to step 1320.

In step 1318, the host system server determines whether the later delivery is more than the configured maximum allowable number of days later than the required date. If it is later than the configured maximum threshold the process moves to step 1322, otherwise the process moves to step 1324. In step 1322, the host system server generates an alert notification to indicate that the sales order delivery date is not within an acceptable range of the revised purchase order required date. The data fields generated in an alert for this business rule may include the alert generation date, buy-side partner ID, PO number, host P/N, P/N description, required date, PO delivery date, remaining quantity due, lead time, PO last update, SO number, manufacturer P/N, P/N description, SO delivery date, SO ship date, SO last update, and the delta number of days. The drill down menus available to the supply chain partner receiving this alert include buy-side part master, notification history, sell-side part master, and where used data. The process moves to step 1324.

In step 1324, the host system server determines whether it has reached the end of the purchase order list. If the end of the purchase order list has been reached the process moves to step 1328, otherwise the process moves to step 1326. In step 1326, the host system server moves the file index pointer to reference the next row in the purchase order list before returning to step 1308. In step 1328, the host system server determines whether there are any remaining rows in the sales order result set. If there are any SO rows in the sales order result set that have not been matched with a PO in the purchase order result set the process moves to step 1330, otherwise the process moves to step 1332 and ends. In step 1330, the host system server generates an alert notification to indicate a missing PO. The process moves to step 1332, and ends.

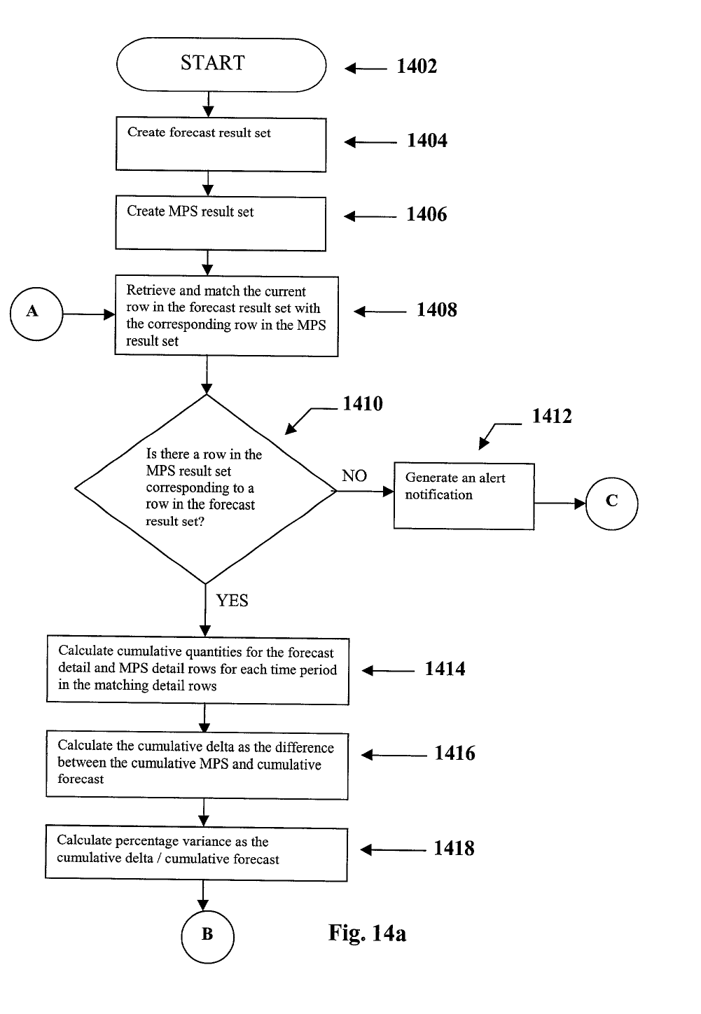

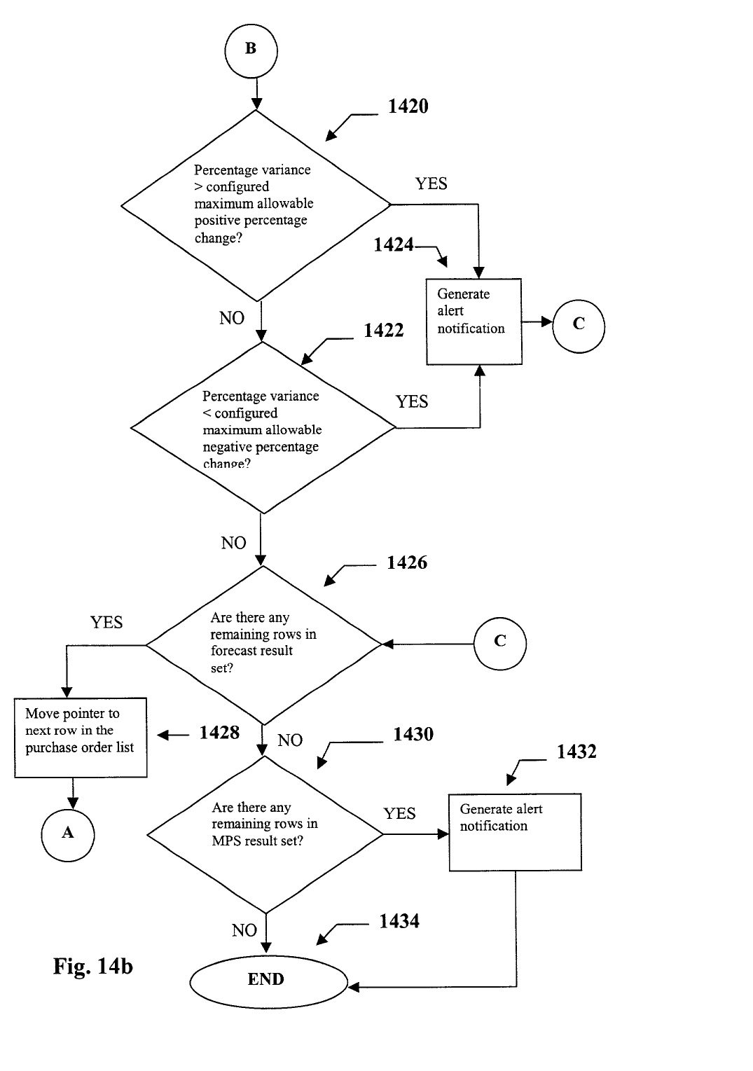

FIGS. 14a-b illustrate the process for identifying a top level demand disconnect business rule in accordance with one embodiment of the invention. This business rule identifies the difference between the host's forecast and a contract manufacturer's manufacturing production system. A contract manufacturer is a company that provides assembly of board level products that are shipped to the hosts's manufacturing plants for final system assembly, test and shipment. Contract manufacturers also provide direct fulfillment of end customer orders with complete systems and/or spares. A manufacturing production system is a scheduling system for production and scheduling systems at the manufacturing floor level. Thus, this business rule compares the host's forecast against the contract manufacturer's manufacturing production system estimated load and generates an alert if the difference between each cumulative forecast exceeds the configured threshold. An alert is generated for only the first period in violation.

The process begins in step 1402. In step 1404, the host system server creates the forecast result set. The forecast set is a collection of aggregated forecast detail rows, for the same period start date, with certain related columns from the corresponding forecast header. The result set may be created by a query that joins that forecast header, i.e. data column, and the forecast detail data rows. The rows of the forecast detail that are selected to form the result set should be the forecast detail rows corresponding to the latest forecast run of the various planning division. Furthermore, the forecast quantities corresponding to the forecasts from the various planning divisions of the sending partner for the same product and period start date should be summed together.

Each row of the forecast result set corresponds to an aggregation of forecast detail rows and may have the following attributes: end user product P/N on all of the forecast headers corresponding to the aggregated forecast detail rows, the minimum plan date from all of the forecast headers corresponding to the aggregated forecast detail rows, the period start date on the forecast detail rows that are aggregated, and the sum of the forecast quantities on the forecast detail rows that are aggregated. The columns of the result set may be grouped by the following attributes: end user product P/N on the forecast header and the period start date on the forecast detail. The rows of the result set may then be sorted in ascending order by the following attributes: first by end user product P/N and then by period start date. The process proceeds to step 1406.

In step 1406, the host system server creates the MPS result set. The MPS result set is a collection of aggregated master schedule detail rows for the same start period and with certain related columns from the corresponding forecast header. The MPS result set is created by a query that performs a join on the master schedule header, i.e., columns, and the master schedule detail rows. The rows of the MPS detail that are selected to form the MPS result set should be the forecast detail rows corresponding to the latest forecast run of the various planning division. Furthermore, the forecast quantities corresponding to the master schedules from the various planning divisions of the receiving partner, i.e. sell-side partner, for the same product and period start date should be summed together.

Each row of the result set corresponds to an aggregation of the master schedule detail rows and may have the following attributes: end user product P/N on each of the master schedule headers corresponding to the aggregated master schedule detail rows, the minimum plan date from all of the master schedule headers corresponding to the aggregated master schedule detail rows, the period start on the master schedule detail rows that are aggregated, and the sum of the forecast quantities on all the master schedule detail rows that are aggregated. The columns of the result set may then be grouped by the following attributes: end user P/N on the master schedule header and the period start date on the master schedule detail. The rows of the result set may then be sorted in ascending order first by end user product P/N and then by period start date. The process moves to step 1408.

In step 1408, the host system server retrieves the row in the forecast result set to which the index pointer is referencing and attempts to find a matching, or corresponding, row in the MPS result set. The matching step may work in an iterative mode, processing a new pair of forecast detail collection row and MPS detail collection row to determine whether a match exists on certain attributes, one of which may be the end user product P/N. The host system server will continue to match forecast detail collection rows with MPS detail collection rows until it has exhaustively searched each result set. The process moves to step 1410.

In step 1410, the host system server determines whether a detail collection row exists in the MPS result set that corresponds to the current detail collection row of the forecast result set. If the host system server was able to match the current detail collection row of the forecast result set with a corresponding detail collection row in the MPS result set the process moves to step 1414, otherwise the process moves to step 1412. In step 1412, the host system server generates an alert notification indicating that there is a missing entry in the MPS result set. The process then moves to step 1426.

In step 1414, the host system server calculates the cumulative quantities for the detail rows and the MPS detail rows for each corresponding time period in the matching detail rows. In step 1416, the host system server calculates the cumulative delta as the difference between the cumulative MPS quantity and the cumulative forecast quantity. In step 1418, the host system server calculates the percentage variance as the (cumulative delta/cumulative forecast) * 100%. In step 1420, the host system server determines whether the calculated percentage variance is greater than the maximum allowable positive percentage change, defined during the configuration of the business rule. If the percentage variance is greater than the maximum allowable positive threshold value the process moves to step 1424, otherwise the process moves to step 1422.

In step 1422, the host system server determines whether the percentage variance is less than the configured maximum allowable negative percentage change. If the percentage variance is less than the configured maximum allowable negative percentage change the process moves to step 1424, otherwise the process moves to step 1426. In step 1424, the host system server generates an alert exception an alert notification to indicate that the sales order delivery date is not within an acceptable range of the revised purchase order required date. The data fields generated in an alert for this business rule may include the alert generation date, contract manager, host P/N, host plan date, contract manager plan date, period, and the delta quantity percent. The drill down menu available to the supply chain partner receiving this alert includes, but is not limited to, a forecast profile. The process moves to step 1426.

In step 1426, the host system server determines whether it has completely searched the forecast result set. If the host system server has completely searched the forecast result set the process moves to step 1430, otherwise the process moves to step 1428. In step 1428, the host system server moves the index pointer to reference the next row in the forecast result set before returning to step 1408. In step 1430, the host system server determines whether it has completely searched the MPS result set after exhausting the forecast result set. If the host system server determines that unmatched rows remain in the MPS result set the process moves to step 1432, otherwise the process moves to step 1434 and ends. In step 1432, the host system server generates an alert notification indicating that at least one forecast row is missing from the forecast result set. The process then moves to step 1434 and ends.

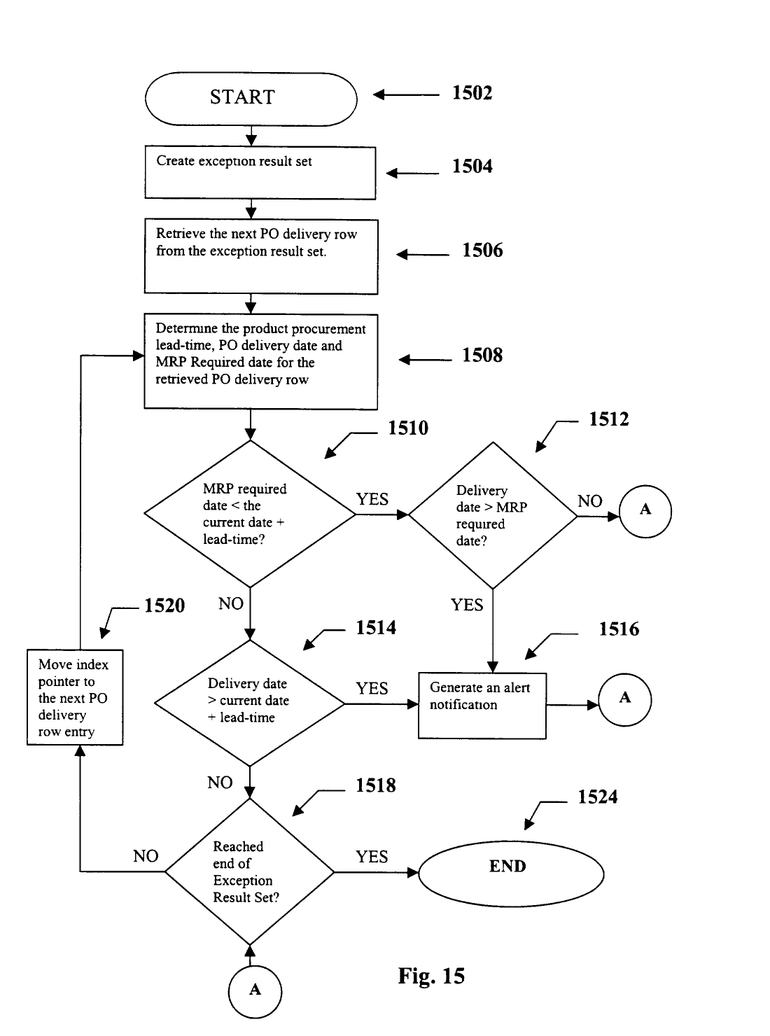

FIG. 15 illustrates the process for identifying a lead-time/delivery date disconnect business rule in accordance with one embodiment of the invention. This business rule identifies purchase orders that have been placed with lead-times different than the quoted lead-times. A lead-time is the time elapsed between when a supply chain participant orders an item and the date when the item arrives at the supply chain participant's warehouse. This time may be measured in days and may be defined as the order time plus the transit time.

The process begins at step 1502. In step 1504, the host system server creates an exception result set. The host system server does this by creating a collection of PO delivery lines that may have the buy side supply chain partner as the partner ID associated with the PO delivery date, have its current delivery date be more than a configurable maximum days late after the manufacturing resource plan (MRP) required delivery date and have been placed on or after the last Monday. The MRP is a resource planning tool that allows a planning division to forecast when it will need specific parts and components.

In step 1506, the host system server retrieves the data from the PO delivery row corresponding to the value of the index pointer. Therefore, the first time that the host system server executes this step, it retrieves the data from the first row of the exception result set. In step 1508, the host system server determines the product procurement lead-time, the PO delivery date and the MRP required date from the retrieved PO delivery row.

In step 1510, the host system server determines whether the MRP required date is earlier in time than a product lead-time number of days after the current date. If the MRP required date is before this date the process moves to step 1514, otherwise the process moves to step 1512. In step 1512, the host system server determines whether the PO delivery date is after the MRP required date. If the PO expected delivery date is after the MRP required date the process moves to step 1516, otherwise the process moves to step 1522.

In step 1514, the host system server determines whether the PO delivery date is later in time than a lead-time number of days after the current date. If the PO expected delivery date is after this date the process moves to step 1516, otherwise the process moves to step 1518. In step 1516, the host system server generates an alert notification to indicate that a PO has been placed with lead-times different than the quoted lead-times. The data fields generated in an alert for this business rule may include the alert generation date, buy-side partner, PO number, host P/N, P/N description, PO delivery date, remaining quantity due, lead time, PO last updated date, SO number, manufacturer number, SO delivery date, SO ship date, remaining quantity due, and SO last updated date. The drill down menus available to the supply chain partner receiving this alert include, but are not limited to, buy-side part master, notification history, PO detail, sell-side part master, SO detail. The process moves to step 1518.

In step 1518, the host system server determines whether the end of the exception result set has been reached. If the end of the exception result set has not been reached, the process moves to step 1524, otherwise the process moves to step 1520. In step 1520, the host system server increases the index pointer to reference the next row in the exception result before returning again to step 1506. In step 1524, the process ends.

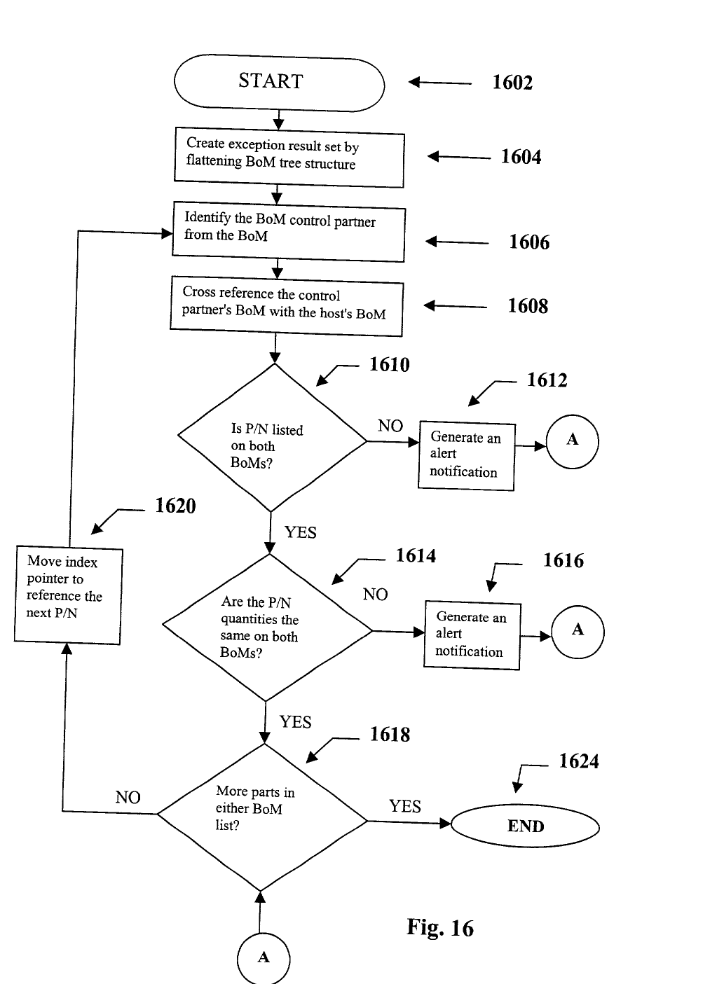

FIG. 16 illustrates the process for identifying a bill of material disconnect business rule in accordance with one embodiment of the invention. This business rule identifies the difference between a summary bill of materials for the host and a control partner. A bill of materials (BOM) is used to communicate BOMs for the host Partner assemblies. Any supply chain partner that transforms material from one P/N to another, must send this data to the host system server. This includes distributors that are doing programming. This data is sent to the host system server daily. A control partner may be a contract manufacturer that provides assembly of board level products that get shipped to the host manufacturing plants for final system assembly, test and shipment.

The process begins in step 1602. In step 1604, the host system server fully explodes the BoM by leveling the BoM tree structure to create an exception result set that may include the individual P/Ns, and their respective quantities, listed in the original BoM structure. In step 1604, the host system server identifies the BoM control partner from the BoM. The host system server may use this information to cross-referencing a specific P/N from the control partner's BoM to the host's BoM.

In step 1606, the host system server cross references, for a specific P/N, the control partner's BoM with the host's BoM. It accomplishes this by searching the control partner's BoM for the P/N listed on the host's BoM that is referenced by the current value of the index pointer in the exception set. In step 1610, host system server determines whether a specific P/N is listed in both the control partner's BoM and the host's BoM. If the P/N is not listed in both BoMs the process moves to step 1612, otherwise the process moves to step 1614. In step 1614, the host system server generates an alert notification to indicate that the P/N is missing from either the host's BoM or the control partner's BoM.

In step 1614, the host system server determines whether the quantities listed for the P/N on both the control partner's BoM and the host's BoM are the same. If the listed quantities are the same the process moves to step 1618, otherwise the process moves to step 1616. In step 1616, the host system server generates an alert notification to indicate the listed difference in the summary bill of materials for the host and the control partner. The data fields generated in an alert for this business rule may include the alert generation date, host partner, contract manufacturer, assembly P/N, component P/N, host quantities, contract manufacturer partner, and contract manufacturer quantities. The drill down menus available to the supply chain partner receiving this alert include, but are not limited to, buy-side part master, notification history, and sell-side part master. The process moves to step 1618.

In step 1618, the host system server determines whether there are any remaining parts to compare in either the host's BoM or the control partner's BoM. If there are more parts to compare in either BoM the process moves to step 1620, otherwise the process moves to step 1624, and ends. In step 1620, the host system server moves the index pointer to reference the next P/N in the exception list before returning again to step 1608.

The present system also includes a business rule function that allows a supply chain participant to view summary supply chain statistics of an associated supply chain partner. This functionality greatly increases supply chain visibility and enhances the flow of supply chain information among all participants in the chain. This business rule may, but is not limited to, return the following statistics for a given supply chain partner: the number of planned orders in lead-time, the number of planned orders in lead-time and lead-time+4 weeks, the number of S/D disconnects in lead-time, the number of S/D disconnects between the lead-time and lead-time+4 weeks, the number of pulls in the POs, the number of push outs in the POs, the number of relative baseline disconnects, the number of fixed baseline disconnects, and the number of forecast time fence disconnects.

It will be apparent to those skilled in the art that various modifications and variations may be made to the system and method for enabling a configurable electronic business exchange platform without departing from the spirit or the scope of the invention. Thus, it is intended that the present invention cover the modifications and variations of this invention, provided that they come within the scope of any claims and their equivalents.

What is claimed is:

1. A method for managing supply chain information in a supply chain network, comprising:
establishing at least one configurable business rule, the configurable business rule including at least one event capable of being monitored;
executing the at least one business rule;
determining the occurrence of the at least one event following execution of the at least one configurable business rule; and
sending at least one alert in response to the determining step.

2. The method according to claim 1, further including the step of retrieving selected information in response to the at least one alert, the selected information associated with the at least one alert.

3. The method according to claim 2, wherein the retrieving step includes presenting the at least one user receiving the at least one alert with a plurality of information types for selection.

4. The method according to claim 3, wherein the at least one user is one of a supplier, a buyer, and a supply chain network host.

5. The method according to claim 3, wherein the plurality of information types includes a drill down menu.

6. The method according to claim 1, further including the step of generating a customized report based upon the determining step.

7. The method according to claim 1, wherein the establishing step is performed by a supply chain network host.

8. The method according to claim 1, wherein the at least one configurable business rule is a customized business rule including at least one associated parameter.

9. The method according to claim 1, wherein the at least one configurable business rule is one of a set of predetermined business rules having at least one associated parameter.

10. The method according to claim 1, wherein the at least one configurable business rule is one of:
an expected delivery disconnect business rule, an unplaced purchase order business rule, a late purchase order receipt business rule, a late sales order shipment business rule, a late trigger start business rule, a supply/demand disconnect business rule, a baseline forecast disconnect business rule, a forecast time disconnect business rule, a lead-time disconnect business rule, a sales order change business rule, a top level demand disconnect business rule, a lead-time/delivery date disconnect business rule, and a bill of material disconnect business rule.

11. The method according to claim 1, wherein the at least one configurable business rule includes instructions for monitoring supply chain data.

12. The method according to claim 1, wherein the at least one configurable business rule includes supply chain partner information.

13. The method according to claim 1, wherein the determining step includes interrogating at least one supply chain information database.

14. The method according to claim 11, wherein the at least one supply chain information database is one of a remote database, a supply chain partner database, and a host database.

15. The method according to claim 1, wherein the step of establishing the at least one configurable business rule is carried out by at least one user of the supply chain network.

16. The method according to claim 15, wherein the at least one user is one of a supplier, a buyer, and a supply chain network host.

17. A system for monitoring supply chain information in a supply chain network comprising:
at least one user interface for establishing at least one configurable business rule; and
a host system server for executing the at least one configurable business rule received from the at least one user interface.

18. The system according to claim 17, wherein the host system server determines the occurrence of at least one event associated with the at least one configurable business rule and sends at least one alert message to the at least one user interface in response to the occurrence of the at least one event.

19. The system according to claim 17, wherein the user interface is one of a buyer interface, a supplier interface and a host interface.

20. A computer program product comprising a computer useable medium having computer readable code embodied thereon, the computer program product adapted to effect the steps comprising:
establishing at least one configurable business rule, the configurable business rule including at least one event capable of being monitored;
executing the at least one business rule;
determining the occurrence of the at least one event following execution of the at least one configurable business rule; and
sending at least one alert in response to the determining step.

21. A business rule for matching purchasing information with sales information in a supply chain network, the business rule executing the steps of:
creating a placed purchase order set based upon a plurality of placed purchase orders;
creating a sales order set based upon a plurality of sales orders;
matching each placed purchase orders in the purchase order set with the corresponding sales orders in the sales order set;
generating an alert notification in response to the matching set;
determining whether a purchase delivery order date and a requested quantity ordered in the placed purchase orders matches a sales delivery order date and a requested quantity shipped in the sales orders; and
generating an alert notification in response to unmatched purchase delivery order and sales delivery order dates and unmatched requested quantity ordered and requested quantity shipped information.

22. A business rule for monitoring a variance between placed purchase orders and planned purchase orders in a supply chain network, the business rule executing the steps of:
creating a placed purchase order set of placed purchase order;
creating a planned purchase order set of planned purchase orders;
matching each purchase order in the purchase order set with the corresponding planned purchase order in the planned purchase order set;
summing quantities ordered from related placed purchase orders in the placed purchase order set;
summing quantities ordered from related planned purchase orders in the planned purchase order set;
determining whether a difference between the summed quantities for each related placed purchase orders and the corresponding summed quantities for each related planned purchase orders exceeds a maximum threshold level; and
generating an alert in response to the determining step.
